(19) United States
(12) Patent Application Publication
(10) Pub. No.: US 2020/0351590 A1
(43) Pub. Date: Nov. 5, 2020

(54) MUSIC COLLAR

(71) Applicant: DEEP ELECTRONICS GMBH, Munich (DE)

(72) Inventors: Stefan SUBE, Haar (DE); Frederik PODZUWEIT, München (DE); Stefan MITTNIK, Flintbek (DE)

(21) Appl. No.: 16/753,960

(22) PCT Filed: Sep. 18, 2018
(86) PCT No.: PCT/EP2018/075205

§ 371 Date: Apr. 6, 2020

(30) Foreign Application Priority Data
Oct. 9, 2017 (EP) 17195550.3

(51) Int. Cl. H04R 5/033; H04R 5/02

(52) U.S. Cl. CPC H04R 5/0335; H04R 2460/13; H04R 2400/03; H04R 5/02

(57) ABSTRACT

The invention discloses a music collar, wherein the music collar is configured as a wear around the neck device, and the music collar comprises: a main frame, comprising a rear-left vibration pad and a rear-right vibration pad, configured to directly or indirectly contact the soft tissue of the back part of the neck of a person wearing the music collar; and wherein the vibration pads transform an input electrical signal to vibrations and transfer the vibrations to the soft tissue of a person wearing the music collar. The invention also discloses a contact plate, preferably for use with a music collar, more preferably for use with a vibration pad, comprising: a first surface, configured to attach the contact plate to a vibration pad; and at least one of a convex second surface and/or a concave second surface configured to facilitate the contact between the vibration pad and the body of a person; and at least one hole. Further the invention discloses a system comprising: a music collar, comprising at least two rear vibration pads contacting the back of the neck of a person wearing the music collar; and at least one contact plate attached to the vibration pads of the music collar; and wherein the contact plates are configured to facilitate the contact between the vibration pads and the body of a person wearing the music collar.

### FIELD OF INVENTION

The current invention is related to a device and system for converting an electrical signal to vibrations and for enabling users to feel such vibrations.

### INTRODUCTION

Music is becoming more and more part of everyday life for many persons. Devices such as loudspeakers and headphones are developed over time to allow individuals to listen to music or other audible sounds. Due to such development, quality of the sound they produce, has improved resulting in better experience and more pleasure for the users. Furthermore, other types of products are developed for improving the experience of the users. An example of a category of such devices are the ones that transform the electrical signal of an audible sound to vibrations and transfer such vibration to the human body. Most of such devices are used as a hearing-aid for hearing impaired persons.

U.S. Pat. No. 4,606,329A describes an implantable electromagnetic middle-ear bone-conduction hearing aid device. The device utilizes a sound processing component that converts sound into an analog electromagnetic signal and has an output transmitter adapted to be placed supercutaneously on the skull of the user for transmitting the electromagnetic signal transcutaneously. A vibration generating component is implanted in any of the small bones of the ossicular chain in the middle-ear for receiving the subcutaneous electromagnetic signal from the signal receiving and transmitting component and for vibrating the ossicular chain in response to such electromagnetic signal to stimulate normal functioning of the inner ear to create the perception of sound in the hearing-impaired user.

U.S. Pat. No. 5,687,244A describes a bone conduction speaker and mounting system. Shortly summarized herein a bone conduction speaker or transducer is mounted against a person's body, preferably against the sternum. An audio signal is fed to the bone conduction speaker or transducer which converts the audio signal to vibrations. The bone conduction speaker or transducer transmits the vibrations to the person's rib-cage which will then resonate in synchronism with the input audio signal.

While the bone conduction mechanisms of the prior art may be satisfactory in some instances, they may have certain drawbacks and limitations. The main principle after bone conduction mechanism is transferring vibration to the bones. But, the use for relatively long period of time of such devices may cause pain or pleasureless feeling, especially on the bones being conducted by the vibrations. Furthermore, some devices of the prior art comprise implantable parts.

### SUMMARY

In a first embodiment, the invention discloses a music collar, wherein the music collar is configured as a wear around the neck device. The music collar comprises a main frame. The main frame comprises a rear-left vibration pad and a rear-right vibration pad. The rear-left vibration pad and the rear-right vibration pad are configured to directly or indirectly contact the soft tissue of the back part of the neck of a person wearing the music collar.

That is, the music collar can comprise at least two vibration pads positioned in the main frame, one in the left part of the main frame and the other on the right part of the main frame. The main frame is positioned on the rear part of the music collar, thus the vibration pads based on their position on the music collar are referred as the rear-left vibration pad (i.e. the one positioned on the left part of the main frame) and the rear-right vibration pad (i.e. the one positioned on the right part of the main frame).The music collar is configured such that when worn by a person, the rear-left vibration pad can directly or indirectly contact the left part of the back of the neck of the person and the rear-right vibration pad can directly or indirectly contact the right part of the back of the neck of the person. That is, if the vibration pads directly contact the soft tissue, such as the skin, of the neck, then direct contact is established between the neck and the vibration pads. However, if there exist another medium, such as clothes, between the vibration pads and the soft tissue of the neck such as the skin, then indirect contact is established between the vibration pads and the neck of the person. The rear vibration pads can be advantageous as they allow the person wearing the music collar feel vibrations produced by the music collar through the soft tissue of the back of the neck.

The vibration pads comprised by the music collar transform an input electrical signal to vibrations and transfer the vibrations to the soft tissue of a person wearing the music collar. That is, an electrical signal can be provided as an input to the vibration pads. The vibration pads are configured to transform the energy (or a fraction of the energy) comprised by the input electrical signal to kinetic energy of certain parts of the vibration pads, i.e. certain parts of the vibrations pads can vibrate under the influence of the input electrical signal. Furthermore, the vibrations produced by the vibration pads, can follow certain patterns of the electrical signal. That is, the electrical signal can comprise at least one frequency component and the vibration pads can produce vibrations according to the at least one frequency component of the input electrical signal. For example, if the electrical signal is a single tone signal with a certain frequency, then the vibration pads can produce vibrations according to the frequency of the signal. If the frequency of the signal is zero (i.e. a direct current is supplied to the vibration pads) then the vibration pads would not produce any vibrations (i.e. the frequency of the vibrations would be zero, meaning, no vibrations). However, if the electrical signal supplied to the vibration pads, is a composite signal, that is, comprising many frequencies, then the vibration pads would vibrate according to the frequency components of the electrical signal. This can be advantageous as it can allow the music collar to produce vibrations according to at least one of the sound, music, audio, voice signals.

Thus, the vibration pads can transform an electrical signal to vibrations of certain parts of the vibration pads. If put in contact with the body of a person, such vibrations can be felt by the person by his sense of touch. Further the electrical signal can comprise audio data. That is, the electrical signal that is supplied to the vibration pads, can be created as a result of a transformation of audio data, such as music, to electrical signal. Put it simply, the electrical signal comprises a composition of tones coming from audio data (or data from any audible sound). For example, the music collar and particularly the vibration pads, can allow the feeling of vibrations according to tones coming from audible sounds, by the person's sense of touch. This, can significantly increase the pleasure while hearing to music as you can feel certain tones of the music in your body. Furthermore, the music collar becomes particularly advantageous for hearing-impaired persons, who can feel the music (or at least certain tones of the music) by their sense of touch, as vibrations transferred to their soft tissue of their body.

In some embodiments, the music collar can comprise a left vibration section which is connected with the main frame at the left of the main frame. The left vibration section comprises a vibration pad, which can also be referred as the front-left vibration pad. The front-left vibration pad can be configured to directly or indirectly contact the soft tissue of the left part of the chest of the person wearing the music collar. This can be advantageous as it can allow the person wearing the music collar feel the vibrations in the chest, more specifically through the soft tissue of the left part of the chest.

In some embodiments, the music collar can comprise a right vibration section which is connected with the main frame at the right of the main frame. The right vibration section comprises a vibration pad, which can also be referred as the front-right vibration pad. The front-right vibration pad can be configured to directly or indirectly contact the soft tissue of the right part of the chest of the person wearing the music collar. This can be advantageous as it can allow the person wearing the music collar feel the vibrations in the chest, more specifically through the soft tissue of the right part of the chest.

That is, the music collar can comprise a left vibration section and/or a right vibration section. The left and the right vibration section can be advantageous as they can allow the music collar to comprise more than two vibration pads. In addition, the vibration section can facilitate the mount of the vibration pads to the music collar. The vibration sections can preferably be positioned on the front of the music collar, respectively on the left and the right side. Thus, they can allow the vibration pads to create contact with the chest of the person wearing the music collar. Furthermore, such a positioning allows the music collar to be worn around the neck, extending in the front part towards the chest. Furthermore, extra vibration pads, such as the front vibration pads mounted on the vibration sections, can increase the feeling of vibrations and can also contribute on distributing the vibrations on different parts of the body. They, can further facilitate the creation of a directional feeling of vibrations if controlled independently.

In some embodiments, the music collar can be configured such that the rear-left vibration pad contacts the soft tissue comprising the left part of the superior fibers of the trapezius muscle of the person wearing the music collar. In some embodiments, the music collar can be configured such that the rear-right vibration pad contacts the soft tissue comprising the right part of the superior fibers of the trapezius muscle of the person wearing the music collar. In some embodiments, the music collar can be configured such that the front-left vibration pad can contact the soft tissue below the left clavicle bone comprising the left part of the pectoralis major muscle, preferably the pars clavicularis part of the left pectoralis major muscle. That is, the front-left vibration pad can preferably contact the soft tissue of the inner part (i.e. the part that is closer to the sternum) of the left part of the chest. In some embodiments, the music collar can be configured such that the front-right vibration pad can contact the soft tissue below the right clavicle bone comprising the right part of the pectoralis major muscle, preferably the pars clavicularis part of the right pectoralis major muscle. That is, the front-right vibration pad can preferably contact the soft tissue of the inner part (i.e. the part that is closer to the sternum) of the right part of the chest. Such a positioning of the music collar, more specifically of the vibration pads of the music collar, with respect to the body of the person wearing the music collar can be advantageous as increases the feeling of the vibrations through the soft tissue of the body.

That is, in the first embodiment, a music collar that can comprise at least two vibration pads is described, more specifically at least comprising a rear-left and a rear-right vibration pad. In addition, in some embodiments the music collar can comprise up to four vibration pads: a rear-left, rear-right, front-left and front-right vibration pad, positioned as explained in the previously presented embodiments. That is, the rear-left vibration pad can contact the soft tissue comprising the left part of the superior fibers of the trapezius muscle, the rear-right vibration pad can contact the soft tissue comprising the right part of the superior fibers of the trapezius muscle, the front-left vibration pad can contact the soft tissue comprising the left part of the pectoralis major muscle, preferably the pars clavicularis of the left pectoralis major muscle and the front-right vibration pad can contact the soft tissue comprising the right part of the pectoralis major muscle, preferably the pars clavicularis of the right pectoralis major muscle. The particular upper mentioned contact places with the human body of a preferred embodiment (also referred as the preferred contact spots, or contact spots) can be advantageous for maximizing the feeling and the pleasure the user of the music collar can get by the vibrations produced by the vibration pads of the music collar. At the same time, said particular contact spots with the human body can be advantageous such that to reduce uncomfortable feeling the user can get from the vibrations, such as pain.

In a particular test, it was found that the upper mentioned contact spots with the human body for maximizing the feeling and the pleasure and at the same time minimize the uncomfortable feeling the user get from the vibrations produced by the vibrations pads. In the said test nine participating persons were asked to try different embodiments of the music collar wherein each embodiment was configured to contact the body of the persons on different parts. Then, for each trial the participating persons were asked to evaluate their experience with a grade ranging from 1 to 6, with 1 expressing the best experience (i.e. the feeling of vibrations is the highest, the pleasure from vibrations is the highest, the uncomfortable feeling is the lowest) and 6 expressing the worst experience (i.e. the feeling of vibrations is the lowest, the pleasure from vibrations is the lowest, the uncomfortable feeling is the highest). Any grade in between represents different levels between the two extremes 1 and 6 as also depicted in the legend of Table 1 (shown in FIG. 10).

During the test, the music collar was configured such that it could contact different parts of the body of person. The following tests were conducted:

Test 1. The vibration pads of the music collar were put in contact with the front part of the neck in both sides left and right (i.e. front-left and front-right of the neck).

Test 2. The vibration pads of the music collar were put in contact with left side and the right side of the neck.

Test 3. The vibration pads of the music collar were put in contact with the back part of the neck in both sides left and right (i.e. rear-left and rear-right of the neck).

Test 4. The vibration pads of the music collar were put in contact with the inner part of the chest (i.e. the part of the chest closer to the sternum bone) in the right and the left side.

Test 5. The vibration pads of the music collar were put in contact with the outer part of the chest (i.e. the part of the chest that is far from to the sternum bone) in the right and the left side.

Test 6. The vibration pads of the music collar were put in indirect contact with the atlas bone, more specifically with the middle of the atlas bone.

Test 7. The vibration pads of the music collar were put in indirect contact with the cervical spine.

Test 8. The vibration pads of the music collar were put in indirect contact with the collar bone (i.e. clavicula).

Test 9. The vibration pads of the music collar were put in indirect contact with the skull, in the left and the right part of the skull, behind the ear.

The results from each test are provided in Table 1 (refer to FIG. 10). Note that each user was asked to provide two evaluations (grades), one corresponding to the feeling directly at the moment the test started (the moment when the vibration pads were put in contact with the human body and were turned on) and a couple of minutes after the start of the test.

From the results depicted in Table 1 (shown in FIG. 10) it can be observed, that on average the best results were obtained when the vibration pads were put in contact with the rear-back and rear-right part of the neck (i.e. Test 3). Second best results correspond to Test 4, when the vibration pads were put in contact with the inner part of the chest.

Thus, complying with the results from the test, in a preferred embodiment, the music collar can comprise two vibration pads: a rear-left vibration pad that can create contact with the soft tissue in the back part of the neck comprising the right part of the superior fibers of the trapezius muscle (i.e. the back part of the neck in the left) and a rear-right vibration pad that can create contact with the soft tissue in the back part of the neck comprising the right part of the superior fibers of the trapezius muscle (i.e. the right part of the neck in the right). Further complying with the results from the test, in another preferred embodiment, the music collar can comprise two additional vibration pads: a front-left vibration pad that can contact the soft tissue comprising the left part of the pectoralis major muscle, preferably the pars clavicularis of the left pectoralis major muscle (i.e. the inner part of the left chest) and a front-right vibration pad can contact the soft tissue comprising the right part of the pectoralis major muscle, preferably the pars clavicularis of the right pectoralis major muscle (i.e. the inner part of the right chest).

In some embodiments, the main frame comprises a curved shape, such as a half-circle shape, configured to facilitate the wear around the neck of the music collar. The music collar can be configured to surround the neck of the person wearing the music collar at an angle of at least 120°, preferably at least 180° and at most 240°. This can be advantageous as it can allow the music collar to stay on a person. Furthermore, it can allow the rear vibration pads of the music collar to stay in contact with the soft tissue of the back part of the neck of the person. This can also be advantageous as it can allow the front vibration pads of the music collar to stay in contact with the soft tissue of the chest of the person wearing the music collar. Further, the front opening makes the music collar more comfortable, avoiding for example suffocating feeling, and at the same time facilitates the extension of the left vibration section towards the left chest and the right vibration section towards the right chest. In addition, the ear around the neck of the music collar can be more comfortable as it cannot obstruct your ears and also does not weight on the head, but rather on the shoulders and the chest.

In some embodiments, the contact between the music collar and the body of the person wearing the music collar can be remained by at least one of weight of the music collar, shape of the music collar and at least one strap configured to connect at least two parts of the music collar. The length of the straps can be adjustable. The at least one strap can be configured to connect the left vibration section with the right vibration section or the left vibration section and the right vibration section with the main frame or all of the above.

In some embodiments, the music collar can be configured to avoid contact with the collar bone of the person wearing the music collar. That is, the music collar can be configured such that it cannot contact the collar bone or at least can minimize the transfer of vibrations, produced by the vibration pads to the collar bone (i.e. also referred as clavicula). This can be particularly advantageous when the music collar comprises the front-left and the front-right vibration pads, which are positioned near the collar bone and thus there is a chance for said vibration pads to create contact with the collar bone. Usually, the vibrations on the collar bone may create an uncomfortable feeling. Thus, it can be advantageous for the music collar to avoid contact with the collar bone.

In some embodiments, the music collar can avoid contact with the collar bone by bridging over the collar bone. That is, the music collar can lean over the collar bone, without contacting it, similar to a bridge traversing a river. The music collar, can create contact on the shoulders and the chest of the person, which can allow support for the music collar to bridge over the collar bone. This arrangement can be advantageous, as contact with the inner part of the chest can be preserved (one of the preferred contacting spots with the human body) but at the same time contact with the collar bone can be avoided.

In a particular embodiment, the vibration sections (the left vibration section and the right vibration section) of the music collar can comprise an elongated part and a mount part. The mount part can be configured to mount a vibration pad on it. The elongated part can be desirable as it can be used for arranging the distance between the main frame and the vibration sections. For example, the elongated part can be used with a sliding mechanism. Furthermore, the mount part can facilitate the process of mounting the vibration pads to the music collar.

In some embodiments, the mount part can be thicker than the elongated part such that the mount part can lie on the chest of the person wearing the music collar allowing the elongated part to bridge over the collar bone without contacting it. That is, the mount part of the vibration section can be thicker than the elongated part of the vibration section such that the center of the mount part can be closer to the human body, more particularly to the chest of the person wearing the music collar, than the center of the elongated part. The thicker the mount part, the more distant from the chest the center of the elongated part can be. In addition, the thickness of the mount part (and/or the vibration pad mounted to the mount part) can be configured such that the center of the elongated part can be sufficiently far from the human body, such that the elongated part (and thus the music collar) cannot contact the collar bone.

In some embodiments, the elongated part of the vibration sections can be configured to comprise a curved shape for bridging over the collar bone of the user wearing the music collar.

In some embodiments, the radius of the curve of the elongated part can be in the range of 200 to 800 mm.

That is, in some embodiments, the elongated part can be curved—i.e., can comprise an arc shape, such that in a side view the elongated part cannot be an arc. In some embodiments, the elongated part can comprise a curvature with a radius of at least 200 mm and at most 800 mm. Put it simply, in such embodiments the arc of the elongated part can be part of a circle with a radius in the range of 200 mm to 800 mm. The arc of the elongated part, can further facilitate the collar-bridge feature of the collar bridge embodiment. That is, when the music collar is worn by a user the elongated part can be configured to reduce or avoid contact with the collar bone of the user, by bridging over the collar bone of the user. The arc shape of the elongated part can further facilitate this by increasing the distance between the collar bone and the elongated part. For example, the arc of the elongated part can point in an opposite direction with the collar bone, configured to allow the elongated part and thus the vibration section and thus the music collar to bridge over the collar bone.

In some embodiments, the vibration sections can be configured to comprise a curved shape for bridging over the collar bone of the user wearing the music collar.

In some embodiments, the radius of the curve of the vibration sections can be in the range of 200 to 800 mm.

In some embodiments, the music collar can comprise a shape adjusting element. The shape adjusting element can be configured to connect a first element with a second element, such that the distance between the first and the second element can be adjusted. Furthermore, the shape adjusting element can allow the adjustment of the angle between the first element and the second element connected by the shape adjusting element. In some embodiments, the main frame can comprise a left and a right part. That is, the main frame is separated into two parts. The left and the right part of the main frame can be connected or flexibly joined with each other by a shape adjusting element. This can be advantageous as it can allow the length and/or shape of the main frame and the music collar to be adjusted accordingly. The shape adjusting element, particularly positioned in the main frame, can be advantageous as different persons have different body sizes and also different preferences on wearing the music collar and through the shape adjusting element they can adjust the music collar accordingly. Furthermore, the shape adjusting element can allow the user of the music collar to wear it such that the vibration pads comprised by the music collar can contact the body of the user on the preferred contact spots (as described in some of the above embodiments) or in the user's personal preferred contact spots.

In some embodiments, the shape adjusting element can be configured such that an adjustment of the left part of the main frame can cause a symmetrical adjustment of the right part of the main frame. That is, if a particular adjustment, such as a pull or push, is applied on the left part of the main frame then the structure of the shape adjusting element can allow that simultaneously the right part of the main frame can experience the same adjustment and vice versa if a particular adjustment, such as a pull or push, is applied on the right part of the main frame then the structure of the shape adjusting element can allow that simultaneously the left part of the main frame can experiences the same adjustment. For example, the left part of the main frame can be pulled (extended) a distance d towards the left. That is, each point on the left part of the main frame has traversed a distance d. At the same time, while the left part of the main frame is traversing a distance d to the left, the right part of the main frame is traversing (i.e. moving) same distance d to the right. Put it simply, the left and the right side of the main frame can be always symmetric according to an axis of symmetry that can pass through the center of the main frame and can lie on the same plane as the main frame.

Such a feature of the shape adjusting element, can allow for an efficient shape adjusting of the music collar. For example, a user of the music collar, can adjust the shape of the music collar, such as can extend the length of the main frame, solely by adjusting one of the sides. Furthermore, usually a symmetry between the left and the right side of the music collar can be advantageous. Thus, the user does not have to adjust the left and the right part accordingly to achieve the symmetry between the two sides, but such symmetry is “automatically” achieved by the structure of the shape adjusting element. In addition, the preferred contact spots between the vibration pads and the human body are symmetric to each other. For example, the contact spots on the back part of the neck (i.e. the left and the right superior fibers of the trapezius muscle) are symmetric to some extent (with reference for example to centric vertical axis of the human body). Thus, a symmetry between the rear-left and rear-right vibration pads of the music collar, that preferably can contact the left and the right superior fibers of the trapezius muscle respectively, can be advantageous. Thus, the symmetry feature of the shape adjusting element as described in the above embodiment can be an efficient way for adjusting the shape of the music collar.

In some embodiments, the main frame can comprise a left and a right part that can be joined by a flexible extension which can comprise a flexible material. That is, the main frame of the music collar can comprise two parts, a left part and a right part. For sake of distinction, the left part can be positioned on the left of the music collar and the right part can be positioned on the right of the music collar. The left and the right part can be two distinct parts, that cannot contact each other but they are joined in a flexible manner by a flexible extension. The flexible extension can comprise a flexible material which can allow the flexible extension any of the following: bending, twisting, extending, shrinking.

That is, since the material of the main frame can be rigid, configuring the main frame as a single part, cannot feature any flexibility in adjusting the shape, such as the length, of the music collar. Thus, configuring the main frame to comprise two parts can be advantageous as it can allow the two parts to be connected in a flexible manner, such as by the flexible extension. The flexible extension can comprise shape adjusting features such as bending, extension, twisting, shrinking, thus, allowing the shape of the music collar to be adjusted. In addition, the flexible extension can further be advantageous as in hazardous situations, such as the music collar falling from a certain height or an external force is applied to the main frame that can damage the structure of the main frame, the flexible material and the flexibility that the flexible extension can offer to the main frame can preserve the structure of the main frame from breaking or damaging.

In some embodiments, the flexible extension can comprise an arc shape in the upper part towards the head of the user wearing the music collar, that can be configured to avoid or at least reduce contact with the head of the person wearing the music collar. For example, the flexible extension can comprise a rectangular shape, with one of its sides being a curve or comprising a substantially U shape. The side comprising the curve shape is the side that can contact the head of the person wearing the music collar (i.e. the side that is nearest to the head). That is, the upper side of the flexible extension can comprise a curve or comprising a substantially U shape and wherein up refers to the direction towards the head (for example, the head is the most upper part of the body of a person standing). The arc of the flexible extension can be provided to create a more comfortable contact, or in some embodiments to avoid contact at all, between the head and the flexible extension. The arc of the flexible extension becomes particularly advantageous when the user of the music collar leans his head to the back, or abruptly leans his head to the back. The arc can avoid hard contact, or at least soften the contact to some extent, between the head and the flexible extension.

In some embodiments, the music collar can comprise a sliding mechanism. The sliding mechanism can be configured to flexibly join two elements such that the distance between the elements can be changed. In some embodiments, the main frame and the left vibration section of the music collar are joined by a sliding mechanism. This can be advantageous as it can allow the distance between the left vibration section and the main frame to be adjusted. In some further embodiments, the main frame and the right vibration section of the music collar are joined by a sliding mechanism. This can be advantageous as it can allow the distance between the right vibration section and the main frame to be adjusted. The sliding mechanism, particularly joining the main frame with the left vibration section or the main frame with the right vibration section, can be advantageous as different persons have different body sizes and also different preferences on wearing the music collar and through the sliding mechanism they can adjust the music collar accordingly.

In some embodiments, the music collar can further comprise at least one amplifier module configured to adjust at least one of the amplitude or the frequency of the input electrical signal supplied to the vibration pads of the music collar. The electrical signal at the input of the amplifier module can come from an external device that provides the electrical signals, such as music transferred in the form of the electrical signal, to the music collar. The output of the amplifier module can be connected as input to the vibration pads. Furthermore, the output of the amplifier module can be connected as input to an external device such as headphones. The amplifier module, can be configured to adjust the signal supplied to the vibration pads and/or to the external device. For example, if the power of the signal is to low, then the amplifier module can amplify the signal to the required power level by the vibration pad and/or the external device. The amplifier module can further be configured as a frequency filter for allowing only a certain range of frequencies to be supplied to the vibration pads and/or the external device. For example, the amplifier module can be configured for allowing only signals with a frequency of up to 250 Hz to be supplied to the vibration pads and can allow any signal to be supplied to the external device, such as headphones.

In some embodiments, the amplifier module can be configured to cut-off frequencies above a threshold value, preferably frequencies above 250 Hz, such that the electrical signal supplied to the vibration pads comprises low frequency signals, such as the deep tones, the bass or signals with frequency of no more than 250 Hz. This can be advantageous, as particularly low frequency vibrations can be mostly felt by the sense of touch. For example, signals with a frequency less than 250 Hz (also referred as the bass, or the deep tones), can be easily felt when transformed to vibrations and transferred to the human body. However, high frequency vibrations can be hardly detected or felt by our sense of touch. Thus, instead of transferring the whole range of frequencies to the vibration pads, only the deep tones (i.e. signals with frequency less than 250 Hz) are transferred to the vibration pads. Further, said amplifier module can be advantageous as it can allow for an adjustment of the volume of only the deep tones, without changing the volume of the higher tones.

In some embodiments, the music collar can comprise volume controls configured to control the intensity of the vibrations produced by the vibrations pads. This can be advantageous as it can allow the person wearing the music collar to adjust the intensity of vibrations. Further in some embodiments, the volume controls can be configured to independently adjust the vibration intensity produced by any of the vibration pads of the music collar.

In some embodiments, the volume controls can be configured as bass-level controls and can adjust the volume of the low frequency signals supplied to the vibration pads, preferably the volume of signals with a frequency of no more than 250 Hz. That is, the bass-level control can be configured to control the bass boost or bass level. In other words, the bass-level control can be configured to adjust the level or the amplitude of low-frequency tones, also called the deep tones or the bass. In some embodiments, the bass-level control can adjust the amplitude of the electrical signals with a frequency lower than 256 Hz, such as 16-250 Hz. It can be advantageous for the music collar, to comprise the bass-level controls, as it can allow a user of the music collar to directly and solely adjust the strength of vibrations, i.e. the amplitude or the level of the deep tones or low frequency signals, such as signals with frequency lower than 250 Hz. Increasing the bass-level can increase the feeling of such vibrations by the user and in contrary decreasing the bass-level can decrease the feeling of such vibrations by the user of the music collar.

In some embodiments, the music collar can further comprise a wire connector. The wire connector can be configured to facilitate a wired connection between the music collar and an external device such as headphones, mobile phones or a digital audio player. The connection can be realized by an audio cable. The connection can be used to exchange data such as audio data, music data, voice data, sound data.

In some embodiments, the music collar can further comprise a wireless connector. The wireless connector can be configured to facilitate the creation of a wireless connection between the music collar and an external device such as headphones, mobile phone or digital audio player. The wireless connection can be a Bluetooth® connection. The connection can be used to exchange data such as audio data, music data, voice data, sound data.

That is, the music collar can be configured for connecting with an external device through a wireless and/or wired connection. The external device can be, but not limited to, a music player device, a microphone, headphones, headsets, speakers, external vibration pads. That is, the music collar can exchange data with an external device. This can be advantageous, as the external device can be used for transferring data, such music, to the music collar. For example, the music collar can be connected with a music player device which provides music data to the music collar. The connection with an external device can further be advantageous as the music collar can transfer data, such as music, to an external device. For example, the music collar can be connected with headphones and can provide data, such as music, to the headphones. Thus, a user can hear the music through his ears by the use of headphones and at the same time can feel the vibrations produced by the music collar, wherein the vibrations are according to certain tones of the music, such as low frequency tones (i.e. the bass).

In some embodiments, the music collar can be connected with an external device such as headphones, music players, external speakers, microphone, external audio device, external vibration pads, mobile phone, digital audio player, by a wireless and/or wired connection. In such embodiments, the music collar can be configured such that the frequency of the signal transferred to the vibration pads can be limited to a maximum threshold value, preferably limited to no more than 250 Hz. In addition, the frequency transferred to the external device can comprise the whole audible frequency range, such as no more than 20000 Hz. One advantage of such embodiments, can be the fact that only low frequency signals, which vibrations can effectively be felt by the sense of touch are supplied to the vibration pads. That is, electrical signals can produce vibrations (if supplied to the vibration pads) with the same frequency. For example, a 1000 Hz signal can produce vibrations with frequency 1000 Hz. However, high frequency vibrations can hardly be felt by the sense of touch. Thus, it can be redundant to supply signals with high frequency (such signals with frequency higher than 250 Hz) to the vibration pads. Furthermore, if the whole audible frequency range is transferred to the vibration pads, then the vibration pads can act similar to a speaker. This can result in the production of sound waves which can be heard in the surroundings. Thus, a reduction of the frequency range that is passed to the vibration pads to no more than 250 Hz, in other words allowing only the deep tones to be transferred to the vibration pads, reduces such affect, as the deep sounds can be less heard on the surrounding (or at least they are heard less than the high frequency sound waves).

In some embodiments, wherein the music collar can be connected with an external device, the volume controls can be configured to adjust the intensity of vibrations on the vibration pads, without influencing the volume of the audio in the external device. That is, the music collar can be connected with an external device such as headphones, external speakers, microphone, external audio device, external vibration pads, mobile phone, digital audio player, by a wireless and/or wired connection. Thus, an electrical signal is supplied to the vibration pads causing them to vibrate and an electrical signal is transferred to the external device (in case the external device is headphones than audio is produced). In such embodiments, the volume controls can be configured to adjust the volume only on the vibration pads, i.e. the amplitude of the electrical signal supplied to the vibration pads, without influencing the electrical signal transferred to the external device. In other words, the user of the music collar can increase or decrease only the strength of the vibrations produced by the vibration pads without influencing the sound on the external device.

In some embodiments, the music collar can comprise multiple audio channels. The rear-left vibration pad and the rear-right vibration pad can be controlled independently of each other. That is, in such embodiments the rear-left vibration pad and the rear-right vibration pad comprise their own connection channel, i.e. their own connection to the source of the input signal. Further, in some embodiments the front-left vibration pad is controlled independently of the other vibration pads of the music collar. In some embodiments, the front-right vibration pad is controlled independently of the other vibration pads of the music collar. The independent control of some or all the vibration pads of the music collar can be advantageous as a multi-directional character of the vibrations can be created, such as the stereophonic or the surround-sound effect.

In some embodiments, the music collar can further comprise balance control buttons configured to adjust the strength of vibrations produced by a first group of vibration pads relative to a second group of vibration pads comprised by the music collar. That it, the balance control buttons can allow more power to be supplied to the first group of vibrations pads and less power to the second group of vibration pads. Or, the balance control buttons can allow more power to be supplied to the second group of vibrations pads and less power to the first group of vibration pads. Or the balance control buttons can distribute the power evenly among the first and the second group. In other words, the balance control button can control how much power is supplied (i.e. the power of the electrical signal supplied to the vibration pads) to the vibration pads of each group. By controlling the power of the electrical signal supplied to the vibration pads, preferably the amplitude of the electrical signal supplied to the vibration pads, the strength of vibration produced by each group of vibration pads can be controlled.

In some embodiments, the first group of vibration pads can comprise vibration pads positioned in the rear of the music collar and the second group of vibration pads can comprise vibration pads positioned in the front of the music collar. In such embodiments, the balance can be shifted between the rear and the front vibration pads. In other words, the balance control buttons can configure the vibration pads such that the rear vibration pads produce stronger vibrations than the front vibration pads or vice versa the front vibration pads produce stronger vibrations than the rear vibration pads or the rear and the front vibration pads produce vibrations with the same strength.

In some embodiments, the first group of vibration pads can comprise vibration pads positioned in the left of the music collar and the second group of vibration pads can comprise vibration pads positioned in the right of the music collar. In such embodiments, the balance can be shifted between the left and the right vibration pads. In other words, the balance control buttons can configure the vibration pads such that the left vibration pads produce stronger vibrations than the right vibration pads or vice versa the right vibration pads produce stronger vibrations than the left vibration pads or the left and the right vibration pads produce vibrations with the same strength.

In some embodiments, the music collar wherein the balance control buttons can comprise two or four buttons. Each button can be configured to increase the strength of vibrations in a certain side and/or decrease in the opposite side. For example, if the balance control buttons comprise two buttons they can be configured to adjust the strength of vibrations between the left and the right side or between the rear and the front.

In some embodiments, the music collar can further comprise at least one battery.

In some embodiments, the music collar can further comprise a power button configured to switch the power of the music collar on or off.

In some embodiments, the music collar can be used as a device for feeling vibrations produced by an audio signal. That is, in such embodiments the input electrical signal can be an audio signal.

In some embodiments, the music signal can be used as a massage device. That is, the vibrations produced by the music collar can be used for massaging purposes.

In a second embodiment, a contact plate preferably for use with the music collar, more preferably for use with a vibration pad, is disclosed. The contact plate comprises a first surface configured to attach the contact plate to a vibration pad. The contact plate can be attached to a vibration pads by means of gluing.

Further the contact plate comprises at least one of a convex second surface and/or a concave second surface configured to facilitate the contact between the vibration pad and the body of a person. That is, in some embodiments the contact plate can comprise a convex second surface. In some other embodiments, the contact plate can comprise a concave second surface. In yet other embodiments, the contact plate can comprise a convex second surface and a concave second surface or a combination of a concave and convex second surface. The convex and/or concave second surface can be advantageous as it adjusts the contact surface of the contact plates with the shape of the body that the contact plates can contact.

The contact plates further comprise at least one hole. The hole can be a hollow space in the body of the contact plate. The hole can be in the form of a channel created in the first surface of the contact plate, i.e. the first surface is not a smooth surface. The at least one hole can be advantageous as it does not allow air to be trapped between the vibration pads and the contact plate.

In some embodiments, the contact plate can comprise a circular or elliptical outer shape. That is, in a top view the outer shape of the contact plate can be a circle or an ellipse. The outer shape of the contact plate can be composed of the line comprising all the furthest points in all direction from the center of the contact plate.

In some embodiments, the contact plates can comprise an outer diameter in the range of 20 to 80 mm, preferably in the range of 30 to 55 mm. That is, in case of a circular outer shape the contact plate comprises an outer diameter in the range of 20 to 80 mm, preferably in the range of 30 to 55 mm. In case of an elliptical shape the small, two outer diameters can be defined, the minor diameter and the major diameter, and wherein the major and minor diameter are in the range of 20 to 80 mm, preferably in the range of 30 to 55 mm. In case of an irregular outer shape, then the maximum distance between two points in the contact plate can be in the range of 20 to 80 mm, preferably in the range of 30 to 55 mm.

In some embodiments, the contact plates can comprise a thickness in the range of 0.5 to 15 mm, preferably in the range of 2 to 6 mm. The thickness of the contact plates can define the distance between the first surface and the second surface of the contact plate.

In other words, the contact plate can comprise a first surface and a second surface (i.e. a concave second surface and/or a convex second surface). For sake of a reference system the first side can be lower than (or beneath) the second surface. The plane passing through the three lowest points of the first surface can be defined as a base plane, wherein the height of each point on the base plane is zero. The height of the contact plate can be defined, throughout this text, as the length of the segment perpendicular to the base plane from a point in the second surface (i.e. a concave second surface and/or a convex second surface) to the perpendicular plane. Further, the thickness of the convex contact plate can be defined, throughout this text, as the distance between two points lying on a line perpendicular to the base plane such that one of the points lies on the first surface and the other point lies on the second surface. The distance between the second surface and the first surface of the contact plate, that is the thickness of the contact plate, can be in the range of 0.5 to 15 mm, preferably in the range of 2 to 6 mm.

In some embodiments, the height of the convex contact plate can increase from the outer part of the convex contact plate towards the center of the convex contact plate, thus creating a convex second surface. That is, the height of the convex contact plate in the outer part, is smaller than the height of the convex contact plate in the center. That is, at least three points in the outer part of the convex contact plate can define a base plane wherein the height of each point in the base plane is zero. The distance of any point in the convex second surface of the convex contact plate from the base plane (i.e. the height) increases the closer the point is to a centric axis of the convex contact plate that is perpendicular to the base lane. Put it simply, the convex second surface can comprise a shape similar to the outer surface of a cupola, or truncated sphere, or a truncated ellipsoid. In some embodiments, the thickness of the convex contact plate can be constant (to some extent), meaning that the first and the second surface comprise identical (to some extent) shapes. In simple words, the convex contact plate comprises a shape similar to the outer surface of a cupola, or truncated sphere, or a truncated ellipsoid which are empty from the inside. In some other embodiments, the thickness of the convex contact plate can be equal (to some extent) with the height of the convex contact plate, meaning that the first surface is a flat surface (i.e. that can lie in the base plane). In simple words in such embodiments, the convex contact plate comprises a shape similar to a cupola, or truncated sphere, or a truncated ellipsoid which are non-empty in the inside (i.e. filled with a material such as the material of the first and the second surface).

In some embodiments, the height of the concave contact plate decreases from the outer part of the contact plate towards the center of the contact plate according to at least one direction and stays constant from the outer part of the contact plate towards the center of the contact plate according to at least one other direction. That is, in at least one cross sectional view of the concave contact plate, the concave second surface can appear as a curve pointing downwards (i.e. points in the direction towards the first surface) and in at least one other cross-sectional view of the concave contact plate the concave second surface can appear as a straight line. Put it simply, the shape of the concave contact plate can be similar to the inner shape of a baseless truncated cylinder (i.e. the cylinder is truncated by a plane perpendicular to its base). In some embodiments, the thickness of the concave contact plate can be constant (to some extent), meaning that the first and the second surface comprise identical (to some extent) shapes. In simple words, the concave contact plate comprises a shape similar to the inner shape of a baseless truncated cylinder (i.e. the cylinder is truncated by a plane perpendicular to its base) which is empty from inside. In some other embodiments, the thickness of the concave contact plate can be equal (to some extent) with the height of the concave contact plate, meaning that the first surface is a flat surface (i.e. that can lie in the base plane). In simple words in such embodiments, the convex contact plate comprises a shape similar to the inner shape of a baseless truncated cylinder (i.e. the cylinder is truncated by a plane perpendicular to its base) which is non-empty in the inside (i.e. filled with a material such as the material of the first and the second surface).

In some embodiments, the contact plates are configured such that the sum of the areas of the at least one hole is at least 2%, preferably at least 5% and at most 10%, such as 8% of the total area of the contact plate. The at least one hole of the contact plate can be advantageous as it reduces the pressure of the air that is trapped between the contact plate and the vibration pad. That is, when the contact plate is attached to the vibration pad air can be trapped between them. During vibrations produces by the vibration pads, the volume between the vibration pads and the contact plates filled with the trapped air changes. This can cause changes on the pressure of the trapped air which can result into creation of high pressures. Such high pressures can damage the structure of the vibration pads, or the contact plates or the attachment between the vibration pads and the contact plates. With the presence of at least one hole in the structure of the contact plate the air is not trapped between the contact plate and the vibration pads and thus creation of the high pressure between the vibration pad and the contact plate is avoided. Further the holes of the contact plate can be advantageous as they can be configured to reduce the isolation of the contact area of the body with the contact plates. Thus, the ventilation between the contacted body skin and the contact plate is increased which can result in a reduce of the creation of sweat.

In some embodiments, the first surface is firmly attachable to the vibration pad, preferably by gluing. A firm attachment is advantageous to preserve the connection between the vibration pads and the contact plate during the vibrations produced by the vibration pads. Further a loose attachment would allow the contact plate to vibrate different than the vibration pad, which would distort the desired vibrations produced by the vibration pads.

In some embodiments, the convex second surface of the contact plate can be configured such that the contact surface between the contact plate and the body of the person being in contact with the contact plate is angle independent. That is, the contact area between the convex second surface and the body is constant irrespective of how the contact plate is rotated with respect to the same part of the body being in contact.

In some embodiments, the concave second surface of the contact plate can be configured such that the contact surface between the contact plate and arched body areas such as the neck can be maximized. For example, the concave second surface can comprise a concavity such that the contact area with the body is maximized. This can be advantageous as it can allow for better transmission of the vibrations to the body.

In a third embodiment, a system comprising a music collar and at least one contact plate is disclosed. The music collar comprises at least two rear vibration pads contacting the back of the neck of a person wearing the music collar. The at least one contact plate is attached to the vibration pads of the music collar. The contact plates are configured to facilitate the contact between the vibration pads and the body of a person wearing the music collar.

In some embodiments, the contact plates attached to the rear vibration pads can comprise concave second surfaces. This can be advantageous as the back of the neck comprises a convex shaped surface, thus a concave second surface of the contact plate increases the contact are between the contact plates and the back part of the neck. The soft tissue of the back part of the neck contacted by the contact plates that are attached to the rear vibration pads, can comprise the superior fibers of the trapezius muscle.

In some embodiments, wherein the music collar can comprise the front-left and the front-right vibration pads, the contact plates attached to the front vibration pads comprise convex second surface such that the shape of the contact plate is adapted with the shape of the chest of a person, preferably with the shape of the soft tissue below the clavicle bone comprising the pectoralis major muscle. This can be advantageous, as the contact surface between the body of the person and the contact plane can be angle independent.

In some embodiments, the music collar can be configured to avoid contact with the collar bone of the person wearing the music collar. That is, the music collar can be configured such that it cannot contact the collar bone or at least can minimize the transfer of vibrations, produced by the vibration pads to the collar bone (i.e. also referred as clavicula). This can be particularly advantageous when the music collar comprises the front-left and the front-right vibration pads, which are positioned near the collar bone and thus there is a chance for said vibration pads to create contact with the collar bone. Usually, the vibrations on the collar bone may create an uncomfortable feeling. Thus, it can be advantageous for the music collar to avoid contact with the collar bone.

In some embodiments, the music collar can avoid contact with the collar bone by bridging over the collar bone. That is, the music collar can lean over the collar bone, without contacting it, similar to a bridge traversing a river. The music collar, can create contact on the shoulders and the chest of the person, which can allow support for the music collar to bridge over the collar bone. This arrangement can be advantageous, as contact with the inner part of the chest can be preserved (one of the preferred contacting spots with the human body) but at the same time contact with the collar bone can be avoided.

In some embodiments where the contact plates can comprise at least one hole, the isolation of the contact area of the body of a person with the contact plates can be reduced. This can be advantageous as it can reduce the creation of sweat in the contacted body skin by the contact plates.

In some embodiments, the music collar can be used as a device for feeling vibrations produced by an audio signal.

In some embodiments, the music collar can be used as a massage device.

Below further numbered embodiments of the music collar will be discussed.

1. A music collar (10), wherein the music collar (10) is configured as a wear around the neck device, and the music collar (10) comprises:
a main frame (100), comprising at least a rear-left vibration pad (20) and a rear-right vibration pad (20), configured to directly or indirectly contact soft tissue of a back part of the neck of a person wearing the music collar (10); and wherein
the vibration pads (20) transform an input electrical signal to vibrations and are configured to transfer the vibrations to the soft tissue of a person wearing the music collar (10).

### General Shape and Arrangement of the Music Collar

2. A music collar (10) according to the preceding embodiment, wherein the rear-left vibration pad (20) is configured to contact the soft tissue comprising the left part of the superior fibers of the trapezius muscle (207) of the person wearing the music collar (10).

3. A music collar (10) according to any of the preceding embodiments, wherein the rear-right vibration pad (20) is configured to contact the soft tissue comprising the right part of the superior fibers of the trapezius muscle (207) of the person wearing the music collar (10).

4. A music collar (10) according to any of the preceding embodiments, further comprising a left vibration section (101) connected with the main frame (100) at the left of the main frame (100), and wherein the left vibration section (101) comprises a front-left vibration pad (20), configured to directly or indirectly contact the soft tissue of the left part of the chest of a person wearing the music collar.

5. A music collar (10) according to the preceding embodiment, wherein music collar (10) is configured such that the front-left vibration pad (20) contacts the soft tissue below the left clavicle bone (205) comprising the left part of the pectoralis major muscle, preferably the pars clavicularis part of the left pectoralis major muscle of the person wearing the music collar (10).

6. A music collar (10) according to any of the preceding embodiments, further comprising a right vibration section (102) connected with the main frame (100) at the right of the main frame (100) and wherein the right vibration section (102) comprises a front-right vibration pad (20), configured to directly or indirectly contact the soft tissue of the right part of the chest of a person wearing the music collar (10).

7. A music collar (10) according to the preceding embodiment, wherein music collar (10) is configured such that the front-right vibration pad (20) contacts the soft tissue below the right clavicle bone (205) comprising the right part of the pectoralis major muscle, preferably the pars clavicularis part of the right pectoralis major muscle of the person wearing the music collar (10).

8. A music collar (10) according to any of the preceding embodiments, wherein the main frame (100) comprises a curved shape, such as a half-circle shape, configured to facilitate the wear around the neck of the music collar (10), preferably surrounding the neck of the person wearing the music collar (10) at an angle of at least 120°, preferably at least 180° and at most 240°.

9. A music collar (10) according to any of the preceding embodiment, wherein a contact between the music collar (10) and the body of the person wearing the music collar (10) is remained by at least one of:
weight of the music collar;
shape of the music collar; and
at least one strap with adjustable length configured to connect at least two parts of the music collar (10).

### Collar-Bridge Embodiment

10. A music collar (10) according to any of the preceding embodiments, wherein the music collar (10) is configured to avoid contact with the collar bone (207), preferably by bridging over the collar bone (207) of the person wearing the music collar (10).

11. A music collar (10) according to any of the preceding embodiments, wherein the music collar (10) is configured to bridge over the collar bone (207) by weighting on the shoulders and the chest of the person wearing the music collar (10).

12. A music collar (10) according to any of the preceding embodiments and with the features of embodiment 4 and 6, wherein the vibration sections (101) and (102) comprise an elongated part (110) and a mount part (120) and wherein the mount part (120) is configured to mount a vibration pad (20) on it.

13. A music collar (10) according to the preceding embodiment wherein the mount part (120) is thicker than the elongated (110) such that the mount part (120) can lie on the chest of the person wearing the music collar (10) allowing the elongated part (110) to bridge over the collar bone (207) without contacting it.

14. A music collar (10) according to embodiment 12, wherein the elongated part (110) is configured to comprise a curved shape for bridging over the collar bone of the user wearing the music collar (10).

15. A music collar (10) according to the preceding embodiment, wherein the radius of the curve of the elongated part (110) is in the range of 200 to 800 mm.

16. A music collar (10) according to any of the preceding embodiments and with the features of embodiments 4 and 6, wherein the vibration sections (101) and (102) are configured to comprise a curved shape for bridging over the collar bone of the user wearing the music collar (10).

17. A music collar (10) according to the preceding embodiment, wherein the radius of the curve of the vibration sections (101) and (102) is in the range of 200 to 800 mm.

### Shape Adjusting Elements

18. A music collar (10) according to any of the preceding embodiments, further comprising a shape adjusting element (810), configured to connect a first element with a second element, such that at least one of the distance and angle between the first element and the second element can be adjusted.

19. A music collar (10) according to the preceding embodiment, wherein the main frame (100) comprises a left part (100L) and a right part (100R) connected by a shape adjusting element (810).

20. A music collar (10) according to the preceding claim, wherein the shape adjusting element (810) is configured such that an adjustment of the shape of the music collar (10) using the shape adjusting element (810) and the left part (100L) of the main frame (100) causes a symmetrical adjustment on the right part (100R) of the main frame (100) and vice versa an adjustment of the shape of the music collar (10) using the shape adjusting element (810) and right part (100R) of the main frame (100) causes a symmetrical adjustment on the left part (100L) of the main frame (100)

21. A music collar (10) according to any of the preceding embodiments, wherein the main frame (100) comprises a left part (100L) and a right part (100R) joined by a flexible extension (870) comprising a flexible material.

22. A music collar (10) according to the preceding embodiment, wherein the flexible extension (870) comprises an arc shape in the upper part towards the head of the user wearing the music collar (10), configured to avoid or at least reduce contact with the head of the person wearing the music collar (10).

23. A music collar (10) according to any of the preceding embodiments further comprising a sliding mechanism (860) configured to join a first element with a second element such that the distance between the first element and the second element can be adjusted.

24. A music collar (10) according to the preceding embodiment and with the features of embodiment 4, wherein the main frame (100) and the left vibration section (101) are connected by the sliding mechanism (860).

25. A music collar (10) according to any of the preceding embodiments and with the features of embodiment 6 and 23, wherein the main frame (100) and the right vibration section (102) are connected by a sliding mechanism (860).

### Low Frequency Cut-Off

26. A music collar (10) according to any of the preceding embodiments, further comprising an amplifier module (30) configured to adjust at least one of the amplitude or the frequency of the electrical signal supplied to the vibration pads (20).

27. A music collar (10) according to the preceding embodiment, wherein the amplifier module (30) is configured to cut-off frequencies above a threshold value, preferably frequencies above 250 Hz, such that the electrical signal supplied to the vibration pads (20) comprises low frequency signals such as the deep tones, the bass or signals with frequency of no more than 250 Hz.

### Volume/Bass Control

28. A music collar (10) according to any of the preceding embodiments, further comprising volume controls (60) configured to control the intensity of the vibrations produced by the vibration pads (20).

29. A music collar (10) according to the preceding embodiment, wherein the volume controls (60) adjust the vibration intensity produced by each vibration pad (20) of the music collar (10) independently.

30. A music collar (10) according to any of the preceding embodiments and with the features of embodiment 27, wherein the volume controls (60) are configured as bass-level controls (60) and can adjust the volume of the low frequency signals supplied to the vibration pads (20), preferably the volume of signals with a frequency of no more than 250 Hz.

### External Device Connection

31. A music collar (10) according to any of the preceding embodiments, further comprising a wire connector (70) configured to facilitate a wired connection between the music collar (10) and an external device such as headphones, mobile phone or digital audio player.

32. A music collar (10) according to any of the preceding embodiments, further comprising a wireless connector (40) configured to facilitate a wireless connection, such as a Bluetooth® connection, between the music collar (10) and an external device, such as headphones, mobile phone or digital audio player.

33. A music collar (10) according to any of the preceding embodiments and with the features of embodiment 31 or 32, or 31 and 32, wherein the frequency of the signal transferred to the vibration pads (20) is limited to no more than a threshold value, preferably limited to no more than 250 Hz, and the frequency transferred to the external device comprises the whole audible frequency range.

34. A music collar (10) according to any of the preceding embodiments and with the features of embodiment 29 and any of embodiments 31 or 32, wherein the volume controls (60) are configured to adjust the intensity of vibrations on the vibration pads (20) without influencing the volume of the audio in the external device.

### Independent Audio Channels and Directional Sound

35. A music collar (10) according to any of the preceding embodiments, wherein the rear-left vibration pad (20) and the rear-right vibration pad (20) are controlled independently of each other.

36. A music collar (10) according to any of the preceding embodiments and with the features of embodiment 4, wherein the front-left vibration pad (20) is controlled independently of the other vibration pads (20) of the music collar (10).

37. A music collar (10) according to any of the preceding embodiments and with the features of embodiment 6, wherein the front-right vibration pad (20) is controlled independently of the other vibration pads (20) of the music collar (10).

38. A music collar (10) according to any of the preceding embodiments and with the features of embodiments 35, 36 or 37, wherein a multi-directional perspective of vibrations is created by independently controlling at least two vibrations pads (20).

### Balance Controls

39. A music collar (10) according to any of the preceding embodiments, further comprising balance control buttons (90) configured to adjust the strength of vibrations produced by a first group of vibration pads (20) relative to a second group of vibration pads (20) comprised by the music collar (10).

40. A music collar (10) according to the preceding embodiment, wherein the first group of vibration pads (20) comprises vibration pads (20) positioned in the rear of the music collar (10) and the second group of vibration pads (20) comprises vibration pads (20) positioned in the front of the music collar (10).

41. A music collar (10) according to any of the preceding embodiments and with the features of embodiment 39, wherein the first group of vibration pads (20) comprises vibration pads (20) positioned in the left of the music collar (10) and the second group of vibration pads (20) comprises vibration pads (20) positioned in the right of the music collar (10).

42. A music collar (10) according to any of the preceding embodiments and with the features of embodiment 39 wherein the balance control buttons (90) comprises two or four buttons (90).

### Other Features

43. A music collar (10) according to any of the preceding embodiments, further comprising at least one battery (50).

44. A music collar (10) according to any of the preceding embodiments, further comprising a power button (80) configured to switch the power of the music collar (10) on or off.

45. A music collar (10) according to any of the preceding embodiments, wherein the music collar (10) is used as a device for feeling vibrations produced by an audio signal.

46. A music collar (10) according to any of the preceding embodiments, wherein the music collar (10) is used as a massage device.

Below, contact plate embodiments will be discussed. These embodiments are abbreviated by the letter P followed by a number. Whenever reference is herein made to contact plate embodiments, these embodiments are meant.

P1. A contact plate (300), preferably for use with a music collar (10), more preferably for use with a vibration pad (20), comprising:
a first surface (310), configured to attach the contact plate (300) to a vibration pad (20); and
at least one of a convex second surface (350) and/or a concave second surface (370) configured to facilitate the contact between the vibration pad (20) and the body of a person; and
at least one hole (320).

P2. A contact plate (300) according to the preceding embodiment, comprising a circular or elliptical outer shape.

P3. A contact plate (300) according to any of the preceding contact plate embodiments, comprising an outer diameter in the range of 20 to 80 mm, preferably in the range of 30 to 55 mm.

P4. A contact plate (300) according to any of the preceding contact plate embodiments, wherein the thickness of the contact plate is in the range of 0.5 to 15 mm, preferably in the range of 2 to 6 mm.

P5. A contact plate (300) according to any of the preceding contact plate embodiments, wherein the height of the convex contact plate (300) increases from the outer part of the contact plate (300) towards the center of the contact plate (300), thus creating a convex surface (350).

P6. A contact plate (300) according to any of the preceding contact plate embodiments, wherein the height of the concave contact plate (300)
decreases from the outer part of the contact plate (300) towards the center of the contact plate (300) according to at least one direction and
stays constant from the outer part of the contact plate (300) towards the center of the contact plate (300) according to at least one other direction.

P7. A contact plate (300) according to any of the preceding contact plate embodiments, wherein the sum of the areas of at least one hole (320) is at least 2%, preferably at least 5% and at most 10%, such as 8% of the total area of the contact plate (320).

P8. A contact plate (300) according to any of the preceding contact plate embodiments, wherein the hole (320) is configured to reduce the isolation of the contact area of the body with the contact plates (300), preferably to reduce the creation of sweat and/or increase the ventilation between the contacted body skin by the contact plate (300).

P9. A contact plate (300) according to any of the preceding contact plate embodiments, wherein the hole (320) is configured to reduce the pressure of the air that is trapped between the contact plate (300) and the vibration pad (20).

P10. A contact plate (300) according to any of the preceding contact plate embodiments, wherein the first surface (310) is firmly attachable to the vibration pad (20), preferably by gluing.

P11. A contact plate (300) according to any of the preceding contact plate embodiments, wherein the convex second surface (350) is configured so that the contact surface between the contact plate (300) and the body of the person is angle independent.

P12. A contact plate (300) according to any of the preceding contact plate embodiments, wherein the concave second surface (370) is configured to maximize the contact surface between the contact plate (300) and arched body areas such as the neck.

Below, system embodiments will be discussed. These embodiments are abbreviated by the letter S followed by a number. Whenever reference is herein made to system embodiments, these embodiments are meant.

S1. A system comprising:
a music collar (10), comprising at least two rear vibration pads (20) contacting the back of the neck of a person wearing the music collar (10), according to any of embodiments 1 to 46; and
at least one contact plate (300) attached to the vibration pads (20) of the music collar (10), according to any of contact plate embodiments; and
wherein the contact plates are configured to facilitate the contact between the vibration pads (20) and the body of a person wearing the music collar (10).

S2. A system according to the preceding embodiment, wherein the contact plates (300) attached to the rear vibration pads (20) comprise concave second surface (370).

S3. A system according to the preceding embodiment, wherein the concave second surface (370) maximizes the contact surface between the contact plates (300) and the back of the neck of the person wearing the music collar (10), more preferably maximizes the contact surface between the contact plates (300) and the soft tissue comprising the superior fibers of the trapezius muscle (207).

S4. A system according to any of the preceding system embodiments, wherein the music collar (10) comprises the features of any of embodiments 5 or 7 and wherein the contact plates (300) attached to the front vibration pads (20) comprise convex second surface (350).

S5. A system according to the preceding embodiment, wherein the convex second surface (350) is configured to adapt the shape of the contact plate (300) with the shape of the chest of a person (10), more preferably with the shape of the soft tissue below the clavicle bone (205) comprising the pectoralis major muscle, even more preferably comprising the part clavicularis of the pectoralis major muscle.

S6. A system according to any of the preceding system embodiments, wherein the music collar (10) is configured to avoid contact with the collar bone (207) of the person wearing the music collar (10).

S7. A system according to any of the preceding system embodiments, wherein the music collar (10) is configured to bridge over the collar bone (207) by weighting on the shoulders and the chest of the person wearing the music collar (10).

S8. A system according the preceding embodiment, wherein the convex second surface (350) is configured so that the contact surface between the body of the person and the contact plate (300) is angle independent.

S9. A system according to any of the preceding system embodiments, wherein the hole (320) is configured to reduce the isolation of the contact area of the body with the contact plates (300), preferably to reduce the creation of sweat in the contacted body skin by the contact plate (300).

S10. A system according to any of the preceding system embodiments, wherein the music collar (10) is used as a device for feeling vibrations produced by an audio signal.

S11. A system according to any of the preceding system embodiments, wherein the music collar (10) is used as a massage device.

### BRIEF DESCRIPTION OF THE FIGURES

FIG. 1 depicts a top schematic view of a music collar according to the invention;

FIGS. 2a and 2b show a front view of a person wearing the music collar;

FIG. 3 shows a side view of a person wearing the music collar;

FIG. 4 shows a detailed view of an adjusting element of the music collar;

FIG. 5 shows a top view of a sliding mechanism of the music collar;

FIGS. 6a to 6c depicts another embodiment of the music collar configured to avoid contact with the collar bone;

FIG. 7 depicts another embodiment of the music collar comprising a flexible extension;

FIGS. 8a to 8c depicts a convex contacting plate used with the music collar;

FIGS. 9a to 9d depicts a concave contacting plate used with the music collar;

FIG. 10 depicts results from a test conducted with different embodiments of the music collar.

### DETAILED DESCRIPTION OF THE FIGURES

In the following, exemplary embodiments of the invention will be described, referring to the figures. These examples are provided to provide further understanding of the invention, without limiting its scope.

In the following description, a series of features and/or steps are described. The skilled person will appreciate that unless required by the context, the order of features and steps is not critical for the resulting configuration and its effect. Further, it will be apparent to the skilled person that irrespective of the order of features and steps, the presence or absence of time delay between steps, can be present between some or all of the described steps.

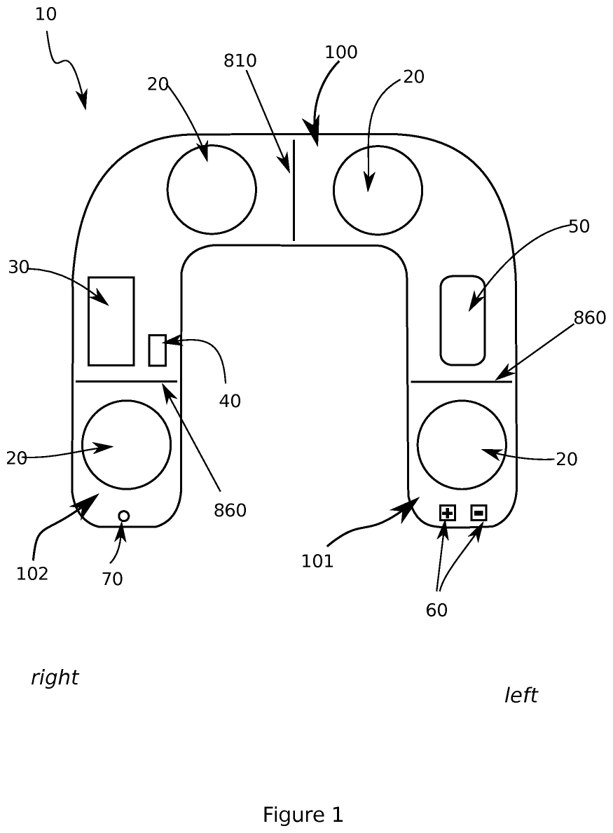

FIG. 1 depicts a top schematic view of the music collar 10 according to the invention. For sake of brevity the elements of the music collar 10 are shown with rectangular or circular shapes. That is, the elements of the music collar 10 are abstracted to the level of building blocks. Thus, unless specified by the context the shape of the elements of the music collar 10 is not limited to the respective shape provided in this figure.

In one embodiment, the music collar 10 can comprise a main frame 100. The main frame 100 comprises a curved shape, such as a substantially U-shape, configured to facilitate the wear of the music collar 10 around the neck of a person. The main frame 100 can comprise a curve similar to the curve of the back of the neck. The main frame 100 can surround the neck in an angle of at least 120°, preferably at least 180° and at most 240°, wherein preferably the back part of the neck is surrounded. In other words, the part of the neck not surrounded by the main frame 100 belongs to the front part of the neck. Put it simply, the music collar 10 surrounds the neck like a collar with its front part opened.

In the left, the main frame 100 is joined with a left vibration section 101, which can also be referred as the left section 101, by a sliding mechanism 860. In the right, the main frame 100 is joined with a right vibration section 102, which can also be referred as the right section 102, by another sliding mechanism 860. For sake of a consistent reference system throughout the text the part of the music collar 10 comprising the left section 101 will be the left part of the music collar 10 and the part of the music collar 10 comprising the right section 102 will be the right part of the music collar 10. In other words, the left section 101 is in the left of the right section 102 and the right section 102 is in the right of the left section 101. Thus, if element A is closer to the left section 101 than another element B, that element A is in the left of element B and the element B is in the right of element A, or the element A is in the left part of the music collar 10 and element B is in the right part of music collar 10. Furthermore, the left section 101 and the right section 102 will be referred as being in the front of the music collar 10 and the main frame 100 will be referred as being in the rear or the back of the music collar 10. That is, the left section 101 and the right section 102 are the front most part of the music collar 10 and the main frame 100 is the rear most part of the music collar 10. Using such reference system, for example, a vibration pad 20 positioned in the left section 101 can be referred as the left-front or front-left vibration pad 20. Put it simply, if a person is wearing the music collar 10, then the left section 101 can be in the left of the person and the right section 102 can be in the right of the person.

The left vibration section 101 can comprise a vibration pad 20, which can also be referred as the front-left vibration pad 20 or the left-front vibration pad 20. The vibration pad 20 can be a device configured to vibrate if properly connected to an electrical signal. That is, when an electrical signal is supplied to the vibration pad 20, it can cause the vibration pad 20 to vibrate, or to create vibration or certain parts of the vibration pad 20 can vibrate. For example, the vibration pad 20 can comprise a magnet positioned in the vicinity of a circular shaped conducting element, such as a coil. The coil is connected with the wires that can transmit the electrical signal. The coil can be wrapped around a piece of metal. When the electrical signal is applied to the coil an electromagnetic field will be created by the coil, turning it into an electromagnet. A fluctuating electrical signal can cause fluctuating electromagnetic field of the coil, which in turn, in combination with the presence of the magnet positioned in the vicinity of the coil, causes the coil to vibrate. This manner of operation is similar to the operation of a loud speaker, that is, the vibration pad 20 produces the vibrations in a similar manner that a loud speaker operates. An example of the vibration pads 20 can be the audio panel exciters.

The music collar 10 can further comprise volume controls 60. The volume controls 60 can comprise at least two buttons, as indicated in FIG. 1 by the signs +and −, wherein the + button 60 when activated causes the amplitude of the electrical signal supplied to the vibration pads 20 to increase and the − button 60 causes the amplitude of the electrical signal supplied to the vibration pads 20 to decrease. It should be noted that the signs provided in FIG. 1 are for illustration purposes only. The volume controls 60 may comprise other signs or may not comprise a sign at all. Also, the volume controls 60 may be arranged in another manner. Furthermore, the volume controls may be positioned elsewhere in the music collar 10, such as in the left section 101, in the right section 102 or in the main frame 100. In an embodiment, the volume controls 60 can be positioned in the front part of the music collar 10, such that a user wearing the music collar 10 can easily access them.

A low amplitude electrical signal can cause the vibration pads 20 to vibrate less than an electrical signal with higher amplitude. Thus, the volume controls 60 can control the strength of the vibrations, or put in other words the amplitude of vibrations. The volume controls 60 can be buttons that switch on when touched and/or pressed.

In some embodiments, the volume controls 60 can also be referred as bass-level control 60. In such embodiments, the bass-level control 60 can be configured to control the bass boost or bass level. That is, the bass-level control 60 can be configured to adjust the level or the amplitude of low-frequency tones, also called the deep tones or the bass. In some embodiments, the bass-level control 60 (also referred in the text as volume controls 60) can adjust the amplitude of the electrical signals (or tones) with a frequency lower than 256 Hz, such as 16-250 Hz.

In some embodiments, the electrical signal supplied to the vibration pads can be unfiltered, that is, as produced by an external device connected with the music collar 10, such as a cellphone, mp3 player, smartphone, radio, music player, etc. That is, in such embodiments, the electrical signal supplied to the vibration pads 20 can comprise the whole range of audible frequencies, i.e. 20 Hz to 20000 Hz. In some other embodiments, the electrical signal supplied to the vibration pads can be filtered. Thus, only signals with a preselected range of frequencies, preferable frequencies lower than 250 Hz (also referred as the bass tones), can be supplied to the vibration pads 20. In either of the upper-mentioned embodiments, the most effective signals producing vibrations in the vibration pads are the low frequency signals (i.e. the deep tones), such as signals in the range of 0-250 Hz. The reason for this, is that the higher the frequency of the vibrations, the harder it becomes for a human to distinguish such vibrations by his sense of touch.

Thus, it can be advantageous for the music collar 10, to comprise the bass-level controls 60, as it can allow a user of the music collar 10 to directly and solely adjust the strength of vibrations, i.e. the amplitude or the level of the deep tones or low frequency signals, such as signals with frequency lower than 250 Hz. Increasing the bass-level can increase the feeling of such vibrations by the user and in contrary decreasing the bass-level can decrease the feeling of such vibrations by the user of the music collar 10.

In some embodiments, wherein the music collar is further connected with external speakers or headphones, the bass-level control 60 can be configured to adjust the vibration strength, i.e. the bass level on the vibration pads 20, without influencing the sound or the amplitude of the sound on the external speakers or headphones.

The right section 102 can comprise another vibration pad 20, which can also be referred as the front-right vibration pad 20 or the right-front vibration pad 20. Further, the right section 102 can comprise a wire connector 70. The wire connector 70 can be configured for connecting an external wire, such as an audio cable, with the music collar 10. In an embodiment, the wire connector 70 can be configured for facilitating the creation of a wired connection with an external device, such that data and/or an electrical signal can be transferred between the music collar 10 and the external device. In an embodiment, the wire connector 70 can comprise a headphone jack 70 for connecting by an audio cable the music collar 10 with the external device. In some embodiments, the wire connector 70 is configured to output the electrical signal supplying the vibration pads 20 to the external device. In such embodiments, the external device can be, for example, headphones, loudspeakers or external vibration pads. In another embodiment, the wire connector 70 can be configured for receiving an electrical signal. In such embodiment, the external device can be, for example, a cellphone, mp3 device, smartphone, radio, or any other device producing an electrical signal suitable for use by the music collar 10. A suitable electrical signal for use by the music collar 10 can be an electrical signal that at least fulfils the power and frequency constraints of the vibration pads 20 and/or the amplifier module 30. For example, an exemplary type of vibration pad 20 can handle electrical signals with continuous power rating of 2 Watt and a frequency in the range of 20 Hz to 20000 Hz and in such example a suitable electrical signal for the music collar 10 is a signal that has a continuous power rating not more than 2 Watt and is in the frequency range of 20 Hertz to 20 Kilo-Hertz. In yet another embodiment the wire connector 70 can be configured for receiving and sending the electrical signal. Furthermore, the wire connector 70 may be positioned elsewhere in the music collar 10, such as in the left section 101 or in the frame 100.

In an embodiment, the electrical signal that is supplied to the vibration pads 20, which can also be referred as the electrical signal, can be an audio signal, that is electrical signal wherein a carrier signal is modulated by audio data, such as music or voice. In such embodiments, the vibration pads 20 will vibrate according to the frequency components of the audio signal such as music or voice.

The music collar 10, can comprise two more vibration pads 20, which can also be referred as the rear vibration pads 20, or the back vibration pads 20, in the back part of the music collar 10, more precisely in the main frame 100. Thus, in an embodiment the music collar 10 can comprise four vibration pads 20, two in the front and two in the back, more precisely one in the left section 101 (i.e. the front-left vibration pad 20), one in the right section 102 (i.e. the front-right vibration pad 20), and two in the back part of the main frame 100 such that one of the vibration pads 20 is in the left part of the music collar 10 (i.e. the rear-left vibration pad 20) and the other is in the right part of the music collar 10 (i.e. the rear-right vibration pad 20). In another embodiment, the music collar 10 can comprise two vibration pads 20 positioned in the front of the music collar 10, more precisely one in the left section 101 and the other in the right section 102. In yet another embodiment, the music collar 10, can comprise two vibration pads 20 positioned in the back part of the main frame 100. In another embodiment, the music collar 10 can comprise at least two vibration pads 20 positioned in any combination of the following positions: front-left, front-right, rear-left, rear-right of the music collar 10.

Further the music collar 10 can comprise a wireless connector 40. The wireless connector 40 can be configured for creating a wireless connection with an external device. Thus, the music collar 10 and the external device can transfer data wirelessly through a wireless data transfer protocol that can be known by both the music collar 10 and the external device. In a specific example, the wireless connector 40 can be a Bluetooth® device and the music collar 10 can be connected through Bluetooth® protocols with an external device that has Bluetooth®. Thus, in such specific example, both the music collar 10 and the external device comprise Bluetooth® modules which can execute a Bluetooth® protocol for establishing and maintaining a wireless connection between the two devices and for exchanging data between them.

The music collar 10 can comprise an amplifier module 30. The amplifier module 30 can be an electronic circuitry configured to amplify the electrical signal received by the wireless connector 40 and/or by the wire connector 70. The role of the amplifier 30 is particularly advantageous when the music collar 10 is wirelessly connected by the wireless connector 40 with an external device. In such cases, the received electrical signal may comprise a very low power that cannot be enough to drive the vibration pads 20. Thus, the amplifier 30 is used to increase the power of the electrical signal to a desired level such that it can drive the vibration pads 20. In case a wired connection is established through the wire connector 70, still the role of the amplifier 30 may be beneficial, in the cases when the external device does not provide enough power to supply the vibration pads 20. This can usually be the case when the external device is for example a smartphone. Put it simply, the electrical signal received by the wireless connector 40 or by the wired connector 70 is supplied as input to the amplifier module 30. If the electrical signal comprises a power that is below a minimum power threshold value or above a maximum power threshold value, the amplifier module 30 can amplify the power of the electrical signal such that it falls within the interval defined by the minimum and maximum power threshold. The minimum power threshold and the maximum power threshold can be defined, for example, by the manufacturer of the vibration pads 20. An electrical signal with average power between minimum power threshold and peak power below the maximum power threshold can drive the vibration pad 20 in its normal operation. Furthermore, the amplifier module 30 can cut-off electrical signals (i.e. reduce the amplitude of electrical signals approximately to zero) that comprise frequencies which are below a minimum frequency threshold or above a maximum frequency threshold (i.e. the amplifier module 30 can operate as a frequency band-pass filter). In another embodiment, the amplifier module 30 can only cut-off electrical signals that comprise a frequency that are lower than a minimum frequency threshold (i.e. the amplifier module 30 can operate as a frequency high-pass filter). In a preferred embodiment, the amplifier module 30 can be configured to cut-off electrical signals that comprise frequencies that are higher than a maximum frequency threshold (i.e. the amplifier module 30 can operate as a low-pass filter). In such embodiments, the amplifier module 30 can cut-off electrical signals that comprise a frequency higher than 250 Hz.

In some embodiments, the power amplifier 30 can be an audio amplifier 30, that is the power amplifier 30 can amplify signals in the audio range (i.e. signals with frequency between 20 Hz to 20000 Hz), preferably low frequency signals such as the bass or the deep tones or signals with frequency up to 250 Hz. Further the power gain coefficient of the amplifier module 30 can be controlled by the volume controls 60 also referred as the bass-level control. That is, the ‘+’ volume control 60 can increase the power gain coefficient of the amplifier module 30. This can increase the strength of the vibrations produced by the vibration pads 20 and thus the feeling of such vibrations by the user of the music collar 10. The ‘−’ volume control 60 can decrease the power gain coefficient of the amplifier module 30. This can decrease the strength of the vibrations produced by the vibration pads and thus the feeling of such vibrations by the user of the music collar 10. The power gain coefficient of an amplifier can be defined as a ratio of the output power over the input power.

In some embodiments, the output of the amplifier module 30 may be connected solely to the vibration pads 20. Further, as described above, the volume controls 60 can control the gain coefficient of the amplifier module 30. Since, in such embodiments, the output of the amplifier module is solely connected to the vibration pads, that is it is not connected to an external device connected to the music collar 10 by the wire connector 70 or the wireless connector 40, this means that the volume or strength of vibrations on the vibrations pads 20 can be adjusted without influencing the signal supplied to the external devices connected to the music collar 10 by the wire connector 70 or the wireless connector 40. Further, the music collar 10 comprises a battery 50. The battery 50 is configured as a power source for a normal operation of the vibration pads 20, amplifier 30 and/or the wireless connector 40.

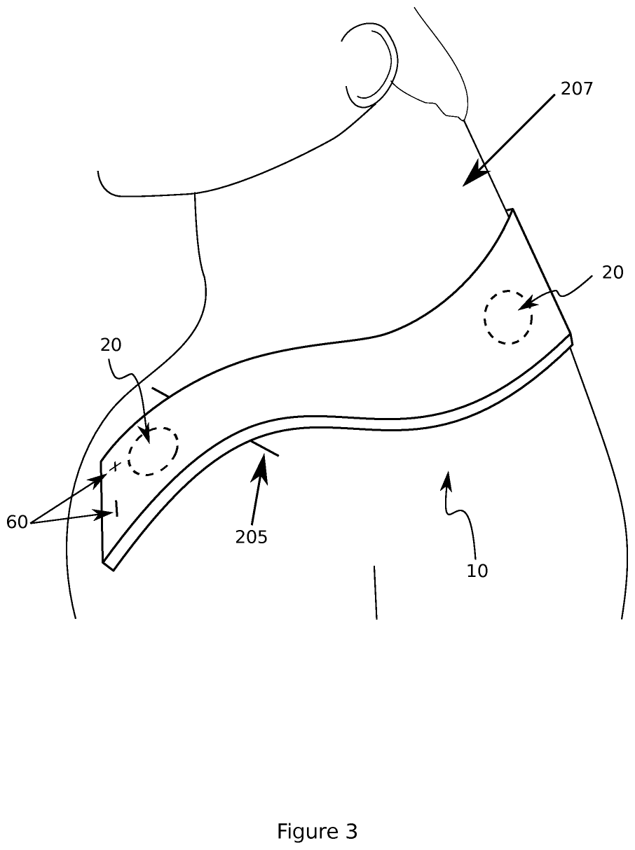

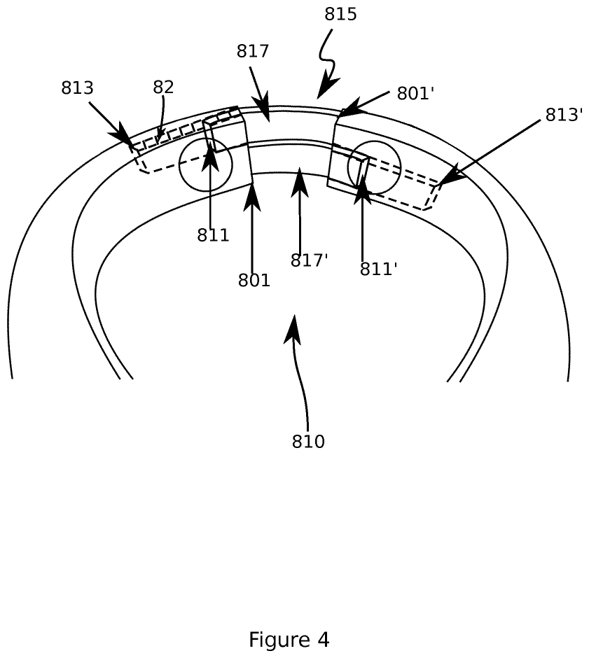

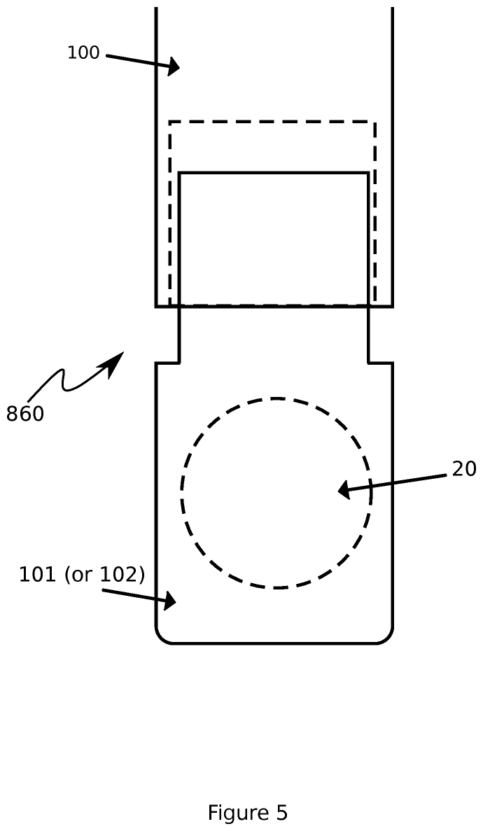

The music collar 10, can further comprise an adjusting element 810 and a sliding mechanism 860 for adjusting the shape of the music collar 10. Refer to FIG. 4 and FIG. 5 for more details.

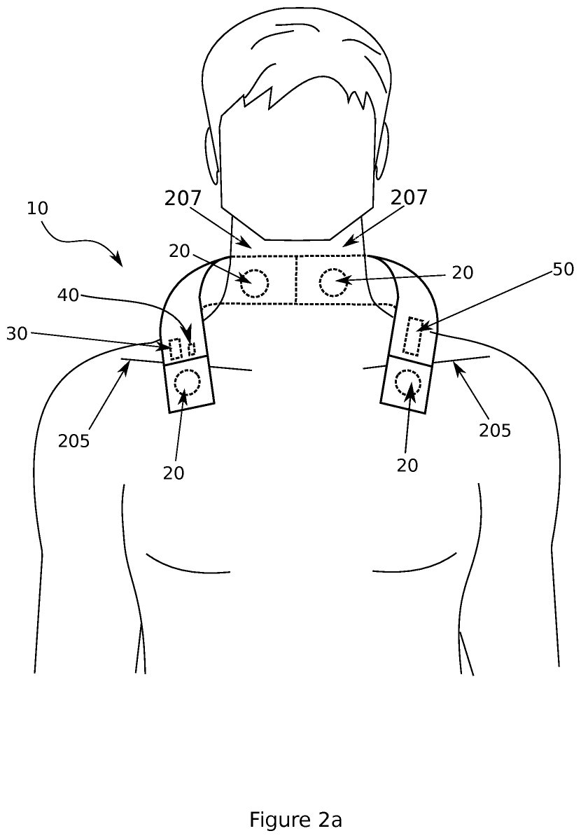

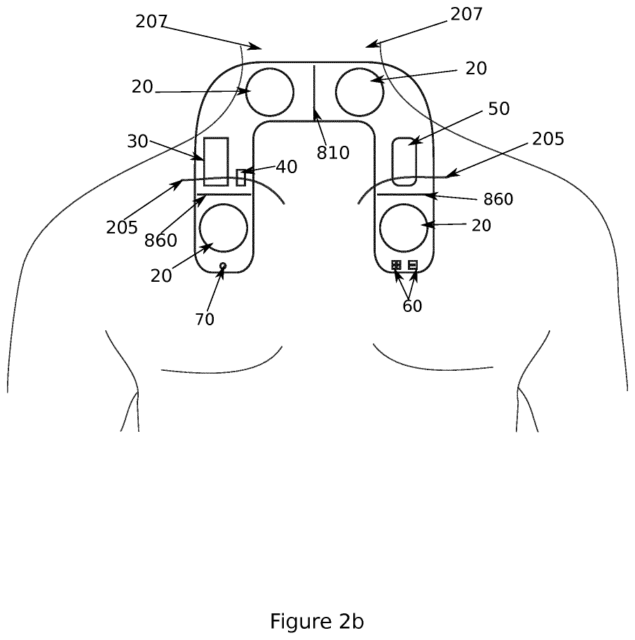

FIG. 2a and FIG. 2b demonstrate the use of the music collar 10 by a person. FIG. 2a depicts a schematic view of a music collar 10 with the main focus on how the music collar 10 can be wrapped around the neck of a person. FIG. 2b depicts a schematic view of the music collar 10 being worn by a person with the main focus on the positioning of the music collar 10 with respect to the body of a person.

The music collar 10 is configured to be worn around the neck. In a preferred embodiment, the music collar 10 can surround at least 120°, preferably at least 180° and at most 240° of the neck. That is, the music collar 10 can create contact with the neck through an angle of at least 120°, preferably of at least 180° and at most 240° (i.e. preferably at least half of a perimeter of the neck can contact the music collar 10). In simple words, the music collar 10 is configured to stand by the neck similar to a collar with its front open. Put it differently, the music collar 10 can comprise an open loop shape, wherein the open section corresponds to the front of the music collar 10, that is, when the music collar 10 is worn by a user the open section of the open loop shape of the music collar 10, will be positioned in the front part of the neck of the person wearing the music collar 10.

In such embodiments, the back of the main frame 100, more preferably the rear vibration pads 20, can be in contact with the soft tissue of the back of the neck of the person wearing the music collar 10. Further, the left vibration section 101, more preferably the front-left vibration pad 20, and the right vibration section 102, more preferably the front-right vibration pad 20, can lie in the chest of the person, that is, can be in contact with the soft tissue of the chest of the person. It should be understood that being in contact with the soft tissue does not necessarily mean that the vibration pads 20 directly touch the soft tissue. The music collar 10 may be worn above or beneath the robes of the person wearing the music collar 10. In case the music collar 10 is worn beneath the robes than the vibration pads 20 are directly in contact with the soft tissue, more precisely with the skin. In case the music collar 10 is worn above the robes then the music collar 10 contacts the soft tissue through the robes, that is, the music collar 10 is in indirect contact with the soft tissue. For sake of brevity, unless otherwise specified by the context, whenever referring to the vibration pads 20 being in contact with the soft tissue, direct or indirect contact with the soft tissue, more precisely with the skin of the person, should be inferred. The same analogy can be made for the case when referring to the music collar 10 contacting parts of the human body such as the muscles. In such cases indirect contact of the vibration pads 20 with the muscles should be inferred.

In such embodiments, as the vibration pads 20 vibrate, their vibration is transferred to the soft tissue of the chest and the neck of the person, when contact between them is realized. Thus, the person can feel the vibration through the soft tissue of the chest and the neck. In a preferred embodiment when the electrical signal running through the vibration pads 20 is an audio signal, the vibration pads 20 can vibrate according to the frequencies of the audio or music or voice comprised in the audio signal. The person wearing the music collar 10 can feel the music through vibrations in the soft tissue of the person's chest and neck. The feeling is particularly high or intensive for the low frequencies of the music, such as the bass, as the vibrations can easily be transferred from the vibration pads 20 to the soft tissue of human body. Nevertheless, the high frequencies, such as the treble, can be felt as well.

As the music collar 10 does not require hearing, it can be advantageous for use by the hearing-impaired persons as they can feel the music through the vibrations of the soft tissue in the chest and the neck. Further, the music collar 10 can be advantageous for use by persons suffering from perforated eardrum, as they can hear the music through bone conduction. So, the vibrations transmitted from the vibration pads 20 to the soft tissue of the human body can be received by the bones as well, which then can conduct such vibrations to the inner ear and the person can be able to percept certain frequencies of the sound or music or audio or voice being transmitted by the music collar 10.

The music collar 10, can be configured such that the front part of the music collar 10 lies below the clavicle bone (i.e. the collar bone) 205. That is, the vibration pad 20 positioned in the left section 101 (i.e. the front-left vibration pad 20), can lie below the left clavicle bone 205 of the person, thus contact with the right part of the chest, more preferably the right pectoralis major muscle, more specifically on the pars clavicularis muscle part of the right pectoralis major muscle. The vibration pad 20 positioned in the right section 102 (i.e. the front-right vibration pad 20), lies below the right clavicle bone 205, contacting with the left part of the chest, more preferably with the left pectoralis major muscle, more specifically on the pars clavicularis muscle part of the left pectoralis major muscle. On the other hand, the vibration pads 20 positioned in the back part of the main frame 100, can contact with the superior fibers of the trapezius muscle. That is, the rear-left vibration pad 20 can contact with the skin above the left part of the superior fibers of the trapezius muscle 207 and the rear-right vibration pad 20 can contact with the skin above the right part of the superior fibers of the trapezius muscle 207. Such a positioning of the vibration pads 20 with respect to the human body is advantageous as it increases the feeling of the vibrations through the soft tissue of the body and also can create a more pleasurefull and better experience.

FIG. 3 depicts a side view of a person wearing the music collar 10. As it can be seen from FIG. 3 the front part of the music collar 10 lies in the chest of the person wearing it. More specifically the front vibration pads 20 (i.e. the vibration pads 20 positioned in the left section 101 and the right section 102) are positioned below the clavicle bone 205 and can be in contact with the soft tissue of the chest, even more specifically, can be in contact with the pars clavicularis of the pectoralis major muscle. On the other hand, the vibration pads 20 positioned on the back part of the music collar 10 (i.e. the vibration pads 20 positioned in the main frame 100) can be in contact with the soft tissue of the back of the neck, more specifically with the superior fibers of the trapezius muscle 207.

In a preferred embodiment, for the vibrations created by the vibration pads 20, to be transmitted in the soft tissue of the human body, it is advantageous that the music collar 10 remains contact with the person's body, as depicted in FIG. 3. In one embodiment, the weight of the music collar 10 allows it to stay in contact to the person's body. In another embodiment, the shape of the music collar 10 is configured or can be configured by the user such that the music collar 10 can preserve contact with the person's body. For example, the music collar 10 can go around the neck and the shoulders, as depicted in FIG. 3, which reduces the degrees of freedom that the music collar 10 can move. Thus, the music collar 10 lies in a more robust manner in the person's body. In yet another embodiment, the music collar 10 may comprise straps (not shown) that keep the music collar 10 more tightly in contact with the person's body. The strap may be provided between the left section 101 and the right section 102. In another embodiment, the strap may be provided between the left section 101 and the main frame 100 as well as between the right section 102 and the main frame 100. In such embodiment, the straps would go under the arms while the music collar 10 lies in the body above the shoulders and around the neck as depicted in FIG. 3. Further the length of the straps may be adjusted.

FIG. 4 depicts a detailed view of the shape adjusting element 810, also may be referred as the adjusting element 810. The main frame 100 is divided into two parts: a left part 100L and a right part 100R. The left part 100L of the main frame 100 comprises the section of the main frame 100 from the left vibration section 101 to a left limiting end 801. The right part 100R of the main frame 100 comprises the section of the main frame 100 from the right vibration section 102 to a right limiting end 801′. The left and the right part of the main frame 100 can be joined by an adjusting element 810.

The adjusting element 810, is configured to adjust at least one of the length and shape of the music collar 10. This can be advantageous, as different persons can comprise different shape and sizes of the neck, shoulders and chest. Furthermore, different persons can have different personal preferences on the way of wearing the music collar 10. For example, someone may prefer to have the music collar 10 more tightened around its neck, shoulders or chest, while someone else may prefer to have the music collar 10 lie loosened around its neck, shoulder or chest. Furthermore, the adjusting element 810 can facilitate the realization of the preferred embodiment, wherein the front vibration pads 20 lie below the clavicle bone 205, in direct or indirect contact with the soft tissue of the chest, more specifically with the pectoralis major muscle, and the rear vibration pads 20 can be in direct or indirect contact with the soft tissue of the neck, more specifically with the superior fibers of the trapezius 207. For example, a person with wide shoulders, neck and chest, may prefer to extend the length of the music collar 10 and adjust its shape such that the music collar 10 fits well in the person's neck, shoulders and chest according to his preference or the upper mentioned preferred embodiment.

The adjusting element 810 can comprise an extension frame 815. The extension frame 815 can slide inside the left and/or the right part of the main frame 100. In an embodiment, the main frame 100 may be empty from inside allowing the extension frame 815 to slide inside of it. In another embodiment, the extension frame 815 can slide alongside the main frame 100. In yet another embodiment, the extension frame 815 may be empty from inside allowing the main frame 100 to slide inside of it. Put it simply, the extension frame 815 and the main frame 100 are configured to slide with respect to each other so that the perimeter of the music collar 10 can be adjusted. The extension frame 815 can have a length of at least 30 mm, preferably at least 40 mm and at most 80 mm, preferably at most 60 mm. Thus, main frame can be extended by a length of at least 30 mm, preferably at least 40 mm and at most 80 mm, preferably at most 60 mm.

The extension frame 815, can comprise a first mount link 817 and a second mount link 817′. The first and the second mount link 817, 817′ may not be fixed with respect to each other or may not be in contact with each other. In one embodiment, the first mount lint 817 is fixed in one of its ends, i.e. attached in a non-releasable manner, with the left part 100L of the main frame 100. The fixing point can be the left limiting end 801′. The second mount link 817′ is fixed in one of its ends, i.e. attached in a non-releasable manner, with the right part 100R of the main frame 100. The fixing point can be the right limiting end 801. The other end of first and second mounting links 817, 817′ are not fixed with the respective parts of the main frame 100. That is, the fist mount link 817 can slide with respect to the right part 100R of the main frame 100 and the second mount link 817′ can slide with respect to the left part 100L of the main frame 100. Such an arrangement can be advantageous as the mount links 817 and 817′ and the respective parts of the main frame 100 are symmetrical every time they are adjusted. Put it simply, a slide with distance d between the first mount link 817 and the right part 100R of the main frame 100 can produce a slide with same distance d between the second mount side 817′ and the left part 100L of the main frame 100.

The first mount link 817 can slide with respect to the right part 100R of the main frame 100 between the maximum extension point 811 and minimum extension point 813. When the non-fixed end of the first mount link 817 is positioned at the maximum extension point 811, the maximum extension of the main frame 100 is achieved, i.e. the maximum distance between the right limiting end 801 and the left limiting end 801′ is achieved. In contrary, when the non-fixed end of the first mount link 817 is positioned at the minimum extension point 813, the minimum extension of the main frame 100 is achieved, i.e. the minimum distance between the right limiting end 801 and the left limiting end 801′ is achieved. The non-fixed end of the first mount link 817 can be positioned in any point between the maximum extension point 811 and the minimum extension point 813.

Similarly, the second mount link 817′ can slide with respect to the right part 100R of the main frame 100 between the maximum extension point 811′ and minimum extension point 813′. When the non-fixed end of the second mount link 817′ is positioned at the maximum extension point 811′, the maximum extension of the main frame 100 is achieved, i.e. the maximum distance between the right limiting end 801 and the left limiting end 801′ is achieved. In contrary, when the non-fixed end of the second mount link 817′ is positioned at the minimum extension point 813′, the minimum extension of the main frame 100 is achieved, i.e. the minimum distance between the right limiting end 801 and the left limiting end 801′ is achieved. The non-fixed end of the second mount link 817′ can be positioned in any point between the maximum extension point 811′ and the minimum extension point 813′.

The adjusting element 810, can further comprise at least one latch 82, preferably a plurality of latches 82. The latches 82 can define different levels of extensions. The latches 82 can be protruding elements from the extension element 815, that can go into respective holes in the inner surface of the main frame 100. In another embodiment, the latches 82 can be protruding elements from the structure of the inner surface of the main frame 100 that can go into respective holes in the outer surface of the extension element 815. In other words, a set of latches 82 and holes can exist in the contact area between the extension element 815 and the main frame 100. In a preferred equilibrium position, each latch 82 is inserted in a hole. This makes the length of the main frame 100 more robust to changes, i.e. increases the minimum force required to change the length of the main frame 100. That is, the extension 815 and the main frame 100 can firmly stay in contact together. Under the influence of an external force (i.e. a user stretching or bringing together the left and the right part of the main frame 100) the latches 82 can be pushed out of the holes they were in and they can go to the neighboring hole, changing the holes one by one, until the external force has stopped acting. When the force stops, a new equilibrium position is reached wherein each latch 82 now is in a new hole. At the same time, the length of the main frame 100 and thus the shape of the music collar 10, are adjusted accordingly. The minimum force required to change the length of the main frame can be at least 5 to 10 N (Newton).

In some embodiments, the shape adjusting element 810 can be configured as a hinge (not shown in any of the figures). The hinge can be configured to adjust the angle between the parts joined by the shape adjusting element. For example, in cases where the music collar 10 is too tight with respect to the person of the user wearing the music collar 10 or the person desires to have the music collar 10 less tight around his neck, then the user can open the hinge positioned in the main frame 100. The opposite can be done to tighten the music collar 10 around the neck. In one embodiment, the music collar 10 comprises only one hinge that connects two parts of the main frame 100. In such embodiments, the hinge is configured to adjust the music collar to surround the neck at an angle 120°, preferably of at least 180° and at most 240°. In another embodiment, the music collar 10 can comprise a plurality of hinges connection the left and the right part of the main frame with each other, and/or the main frame 100 with the left vibration section 101 and/or the main frame 100 with the right vibration section 102. Further, the hinge may comprise at least one latch which can define at least one level of adjusting the angle of the music collar 10.

FIG. 5 depicts a top view of a sliding mechanism 860. The sliding mechanism 860 can be configured for joining the main frame 100 with the left and right vibration sections 101, 102. That is, the music collar 10, can comprise two sliding mechanisms 860 wherein a first sliding mechanism 860 can be configured for joining the left vibration section 101 with the main frame 100 and a second sliding mechanism 860 can be configured for connecting the right vibration section 102 with the main frame 100.

The sliding mechanism 860 can be configured such that an extended part of the left vibration section 101 (right vibration section 102) can slide inside the main frame 100. The main frame 100 can comprise a hallow shape, that is, it can comprise a hole in its inner part. The sliding mechanism 860 can be configured to realize and extension between the left vibration section 101 (right vibration section 102) in the range of 30 to 100 mm, preferably at least 40 mm, or at most 50 mm.

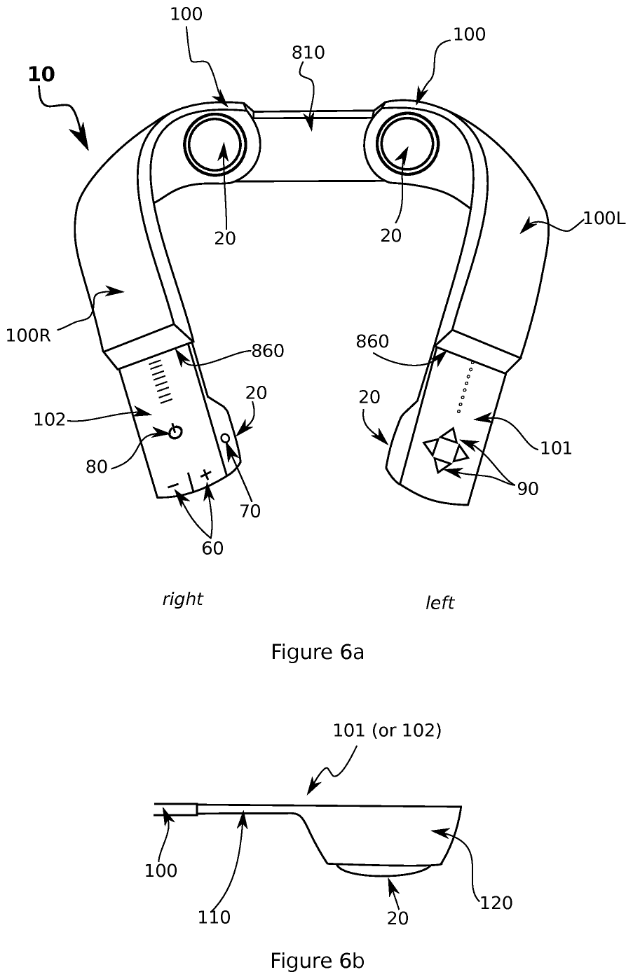

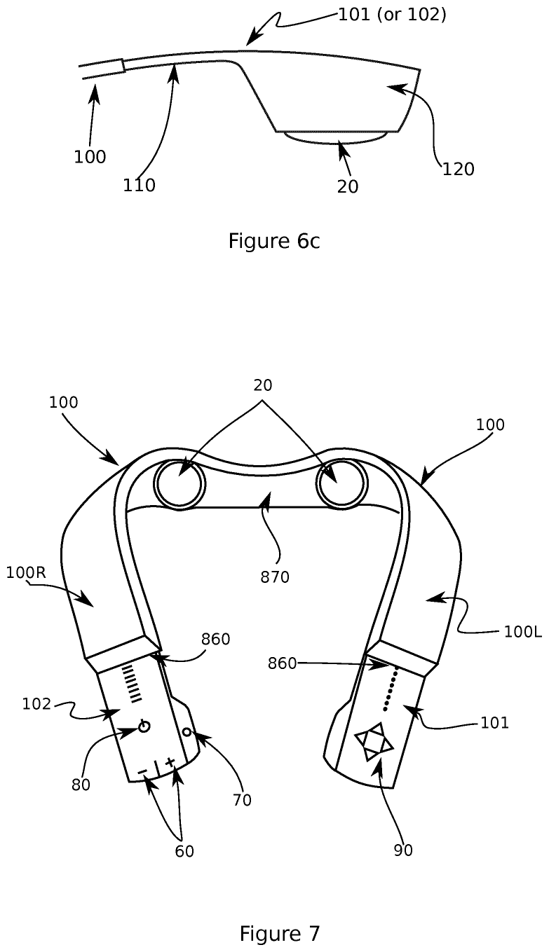

Referring now to FIG. 6, another embodiment of the music collar 10 is depicted. In FIG. 6 (and throughout the description of the drawings), like reference sings denote like structures. Furthermore, some of the features and characteristics described above in conjunction with FIGS. 1 to 5 are also used in the embodiment depicted in FIG. 6. For sake of brevity of description, in the below, only additional features in the embodiment depicted in FIG. 6 may be described in more detail.

The embodiment depicted in FIG. 6 can also be referred as the collar-bridge embodiment. Like the embodiments described in the previous figures, the collar-bridge embodiment of FIG. 6 comprises a main frame 100. The main frame 100 can comprise two parts, the left part 100L of the main frame 100 and the right part 100R of the main frame 100. The left part 100L and the right part 100R of the main frame 100 can be joined by the shape adjusting element 810 (refer to FIG. 4 for more details). Further, the collar-bridge embodiment of the music collar 10 can comprise a left vibration section 101 and a right vibration section 102 (refer to, for example, FIG. 1). The left vibration section 101 can be joined with the main frame 100, more particularly with the left part 100L of the main frame 100, by a sliding mechanism 860. In addition, the right vibration section 102 can be joined with the main frame 100, more particularly with the right part 100R of the main frame 100, by another sliding mechanism 860. Further details for the sliding mechanism can be found with reference to FIG. 5. The collar-bridge embodiment of the music collar 10 can further comprise at least two vibration pads 20, preferably four vibration pads 20. The position of the vibration pads 20 can be such as depicted and described in the embodiment of FIG. 2a and FIG. 2b. That is, in some embodiments, the music collar 10 can be configured such that the rear-right vibration pad 20 contacts the soft tissue comprising the right part of the superior fibers of the trapezius muscle of the person wearing the music collar. In some embodiments, the music collar 10 can be configured such that the front-left vibration pad 20 can contact the soft tissue below the left clavicle bone comprising the left part of the pectoralis major muscle. In some embodiments, the music collar 10 can be configured such that the front-right vibration pad 20 can contact the soft tissue below the right clavicle bone comprising the right part of the pectoralis major muscle. Such a positioning of the music collar 10, more specifically of the vibration pads of the music collar, with respect to the body of the person wearing the music collar can be advantageous as it can increase the feeling of the vibrations through the soft tissue of the body.

Furthermore, the embodiment of the music collar 10 depicted in FIG. 6 can comprise an amplifier module 30, a wire connector 70, a wireless connector 40, volume controls 60 (also referred to as bass-control 60) and a battery 50.

In addition, the collar-bridge embodiments of the music collar 10 can further comprise a power button 80. The power button 80 can be configured for at least one of turning on and turning off the music collar 10. For example, when the music collar 10 is turned off, an activation of the power button 80 (such as pressing or touching the power button 80) can turn the music collar 10 on. Or, when the music collar 10 is turned on, an activation of the power button 80 (such as pressing or touching the power button 80) can turn off the music collar 10.

Further, the collar-bridge embodiment of the music collar 10 can comprise the balance control buttons 90. The balance control buttons 90 can be configured to adjust the strength of the vibration coming from each vibration pad 20 on the music collar 10. In some embodiments, the balance control buttons 90 can adjust the side-to-side strength (i.e. left and right) and/or the rear-to-front strength. That is, the balance control buttons 90 can adjust the strength of vibrations such that the vibration pads 20 positioned on the left of the music collar 10 produce stronger vibrations (i.e. vibrations with higher amplitude) compared to the vibration pads 20 positioned on the right of the music collar 10. Or, vice versa, the balance control buttons 90 can adjust the strength of vibrations such that the vibration pads 20 positioned on the right of the music collar 10 produce stronger vibrations (i.e. vibrations with higher amplitude) compared to the vibration pads 20 positioned on the left of the music collar 10. Similar analogy can be made for adjusting the rear-to-front vibration strength. The balance control buttons 90 can also balance the vibration strength such that every (or at least some) of the vibration pads 20 produce vibrations with same strength.

Further, the collar-bridge embodiment of the music collar 10, depicted in FIG. 6 comprises the collar-bridge feature. The collar-bridge feature is depicted in more detail in FIGS. 6b and 6c, which shows a side view of two different embodiments of one of the vibration sections 101, 102 (i.e. left vibration section 101 and right vibration section 102) of the music collar 10. The collar-bridge feature of the collar-bridge embodiment of the music collar 10, allows the music collar 10 to avoid contact with the collar bone 207 (i.e. clavicle bone 207) by bridging over it. That is, the vibration section 101, 102 can comprise an elongated part 110 and a mount part 120 configured for mounting the vibration pad 20. In some embodiments, the mount part 120 and the vibration pad 20 mounted to the mount part 120, can be thicker than the elongated part 110. In some embodiments, the mount part 120 on its own can be thicker than the elongated part 110. In some embodiments, the transition from the mount part 120 to the elongated part 110 can be an abrupt transition, that is, the transition can be a vertical line (i.e. perpendicular with the elongated part 110). In some other embodiments, such as the one depicted in FIG. 6b and FIG. 6c, the transition from the mount part 120 to the elongated part 110 comprises a slope, that is, the angle between the transition and the elongated part 110 can be at least 20° and at most 90°, preferably at least 45° and at most 75°, such as 60°. It can be understood that when the angle between the transition and the elongated part 110 is 0° than the mount part 120 and the elongated part 110 comprise the same thickness.

In a preferred arrangement, such as the one depicted in FIG. 2a and FIG. 2b, the mount part 120 comprising the vibration pad 20 contacts the soft tissue of the human body below the clavicle bone 207 (refer to FIGS. 2a and 2b). Since, in the collar-bridge embodiment of the music collar 10, depicted in FIG. 6, the mount part 120 with a vibration pad 20 is thicker than the elongated part 110, this allows the elongated part 110 to bridge over the collar bone 207, thus avoiding contact with the collar bone 207 (i.e. the clavicle bone 207). Put it simply, the collar-bridge embodiment of the music collar 10 can contact the body of the user of the music collar 10 in the shoulder area and in the soft tissue below the clavicle bone 207. For example, the main frame 100 contacts the human body in the shoulder area, the mount part 120 contacts with the pectoralis major muscle, while the elongated part stands as a “bridge” over the clavicle bone 207 (using the upper mentioned contact points as support), thus avoiding contact with the clavicle bone 207.

Further, the collar bridge embodiment of the music collar can be realized with vibration sections 101, 102 that can comprise an elongated part 110 with a substantially straight line, such as the one depicted in FIG. 6, and/or with vibration pads 101, 102 that can comprise an elongated part with a curved shape, i.e. arced shape. That is, in some embodiments the elongated part 110 can be configured to comprise a straight shape, that is, in a side view such as the one depicted in FIG. 6b, the elongated part 110 can be a straight line. In some other embodiments, the elongated part 110 can be curved—i.e., can comprise an arc shape, such that in a side view such as the one depicted in FIG. 6c the elongated part 110 cannot be a straight line but an arc. In some embodiments, the elongated part 110 can comprise a curvature with a radius of at least 200 mm and at most 800 mm. Put it simply, in such embodiments the arc of the elongated part can be part of a circle with a radius in the range of 200 mm to 800 mm. The arc of the elongated part, can further facilitate the collar-bridge feature of the collar bridge embodiment. That is, when the music collar 10 is worn by a user the elongated part 110 can be configured to reduce or avoid contact with the collar bone 207 of the user, by bridging over the collar bone 207 of the user. The arc shape of the elongated part 110 can further facilitate this by increasing the distance between the collar bone 207 and the elongated part 110. For example, the arc of the elongated part can point in an opposite direction with the collar bone, configured to allow the elongated part 110 and thus the vibration section 101, 102 and thus the music collar 10 to bridge over the collar bone 207.

Referring now to FIG. 7, another embodiment of the music collar 10 is depicted. In FIG. 7 the collar-bridge embodiment of the music collar 10 is showed. The difference between the embodiment of the music collar 10 depicted in FIG. 6 and the one depicted in FIG. 7 is the manner in which the parts of the main frame 100 (i.e. the left part 100L and the right part 100R) are joined. In FIG. 6, the shape adjusting element 810 is used. In FIG. 7, a flexible material 870 is used for such purpose. It should be noted that the flexible material 870 can also be used with other embodiment of the music collar despite the ones depicted in FIG. 6 or FIG. 7, such as the ones depicted in FIGS. 1 to 5.

The flexible extension 870, can be configured to create a flexible joint between the left part 100L and the right part 100R of the main frame 100. The flexible extension 870 can expand thus, allowing the distance between the left part 100L and the right part 100R of the main frame 100 to be adjusted. The flexible extension 870 can also twist, thus allowing twisting between the left part 100L and the right part 100R of the main frame 100. The flexible extension 870, can comprise a flexible material, such as a rubber material or flexible plastic material.

Further the flexible extension 870, can comprise an arc shape in the upper side (i.e. the side that can create contact with the head of the user of the music collar 10. The arc of the flexible extension 870 can be provided to create a more comfortable contact, or in some embodiments to avoid contact at all, between the head and the flexible extension 870. The arc of the flexible extension 870 becomes particularly advantageous when the user of the music collar 10 leans his head to the back, or abruptly leans his head to the back. The arc can avoid hard contact, or at least soften the contact to some extent, between the head and the flexible extension 870.

To create a better and a more robust contact between the vibration pads 20 and the human body, the vibration pads 20 may further comprise the contact plates 300. The contact plates 300 are attached to the movable parts of the vibration pads 20, such as to the coil of the vibration pad 20. Thus, the contact plates 300 can vibrate as well. In such embodiments, the vibration pads 20 can contact the human body through the contact plates 300. That is, the contact plates 300 are attached to the vibration pads 20 such that they can be between the vibration pads 20 and the person's body when the person is properly wearing the music collar 10.

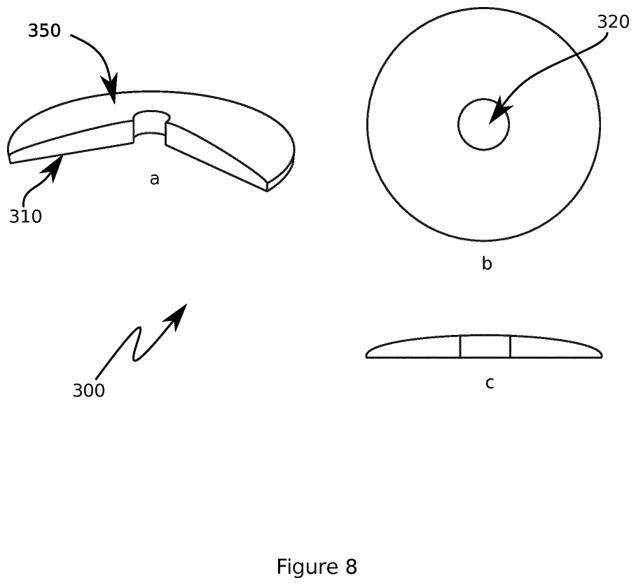

FIG. 8 depicts three different views of a contact plate 300 comprising a convex second surface 350. FIG. 8a depicts a cross sectional view of the contact plate 300 comprising a convex second surface 350. FIG. 8b depicts a top view of contact plate 300 comprising a convex second surface 350. FIG. 8c depict a side view of the contact plate 300 comprising a convex second surface 350. The contact plate 300 comprising a convex second surface 350, as shown in FIG. 8, can be also referred as a convex contact plate 300.

The convex contact plate 300 can comprise a circular outer shape with a diameter in the range of 30 to 55 mm. That is, in a top view, such as the one depicted in FIG. 8b, the shape of the contact plate 300 is a circle. In another embodiment, the convex contact plate can comprise an elliptical outer shape (not shown in any of the figures) with diameters in the range of 30 to 55 mm. That is, in a top view, the shape of the contact plates 300 is an ellipse.

The convex contact plate 300 can comprise a first surface 310. The first surface 310 can be configured to attach the convex contact plate 300 to the vibration pad 20, preferably by means of gluing.

Further, the convex contact plate 300, comprise a convex second surface 350 on the part of the convex contact plate 300 that contacts the human body. That is, in a side view, such as the one depicted in FIG. 8c, the height of the convex contact plate 300 transitions from a smaller value in the outer part of the convex contact plate 300, to a higher value towards the center of the convex contact plate 300. In an exemplary embodiment, the transition can be a linear transition and thus creating an overall shape of a truncated cone, with a hole 320 in its centric axis. In another exemplary embodiment, the transition can be a quadratic transition thus creating an overall structure of a truncated sphere or ellipsoid, with a hole 320 in its centric axis. The height of the convex contact plate 300, can be in the range of 2 to 6 mm.

In other words, the convex contact plate 300 can comprise a first surface 310 and a convex second surface 350. For sake of a reference system the first side 310 is said to be lower than (or beneath) the second surface 350. The plane passing through the three lowest points of the first surface 310 can be defined a base plane, wherein the height of each point on the base plane is zero. The height of the convex contact plate 300 can be defined as the length of the segment perpendicular to the base plane from a point in the convex second surface 350 to the perpendicular plane. The height of the convex contact plate 300 can be in the range of 2 to 6 mm. Further, the thickness of the convex contact plate 300 can be defines as the distance between two points lying on a line perpendicular to the base plane such that one of the points lies on the first surface 310 and the other point lies on the convex second surface 350. Further, a centric axis of the contact plate can be a line passing through the center of the convex contact plate 300, perpendicular to the base plane. The distance of a point from the centric axis can be defined as the length of a segment perpendicular to the centric axis from that point to the centric axis.

In general, for any set of points lying on the convex second surface 350, such that the set of points and the centric axis lie on only one plane, the points within the said set of points with smaller distance to the centric axis have a higher height than the points within the said set of points with higher distance to the centric axis. In some particular embodiments of the convex contact plate 300, such as the one depicted in FIG. 8, wherein the shape of the convex contact plate 300 as seen from the top is a circle, the height of the convex contact plate 300 increases as the distance to the centric axis decreases (i.e. the height of the convex contact plate 300 is inversely proportional to the distance to the centric axis increases).

In some embodiments, the thickness of the convex contact plate 300 can be constant. In such embodiments, the first surface 310 and the second surface 350 comprise similar or identical shapes. In some other embodiments, the first surface 310 can be flat, that is, all the points of the first surface 310 lie on the base plane. In such embodiments, the thickness and the height of the convex contact plate 300 measured at the same point are equal.

The convex contact plate 300 can comprise at least one hole 320. In the exemplary embodiment of FIG. 8 the contact plate 300 comprises one hole 320 which is depicted by the inner circle 320, concentric to the outer circle. The at least one hole 320 can be positioned anywhere in the convex second surface 350. The at least one hole 320 can have any shape as long as its area or the sum of areas of each individual hole is at least 2%, preferably at least 5% and at most 10%, such as 8% of the area of the convex second surface 350. The hole 320 can be advantageous as it can ventilate the contact area between the person's body and the convex contact plate 300, thus avoiding sweating of the skin in the contact areas. Furthermore, the holes 320 can facilitate the maintenance between the convex contact plate 300 and the vibration pads 20. If the hole 320 would not be present, due to vibrations the trapped air between the convex contact plate 300 and the vibration pads 20 can experience a fluctuating pressure, which can achieve high peaks that can damage the connection between the convex contact plate 300 and the vibration pads 20. The presence of such hole 320 cannot allow the pressure of the air between the convex contact plate 300 and the vibration pads 20 reach very high peaks as the air can go in and out.

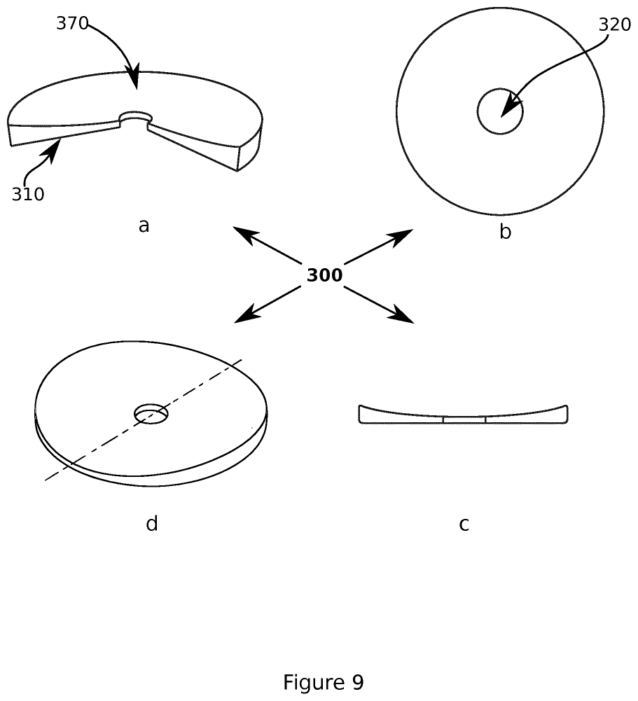

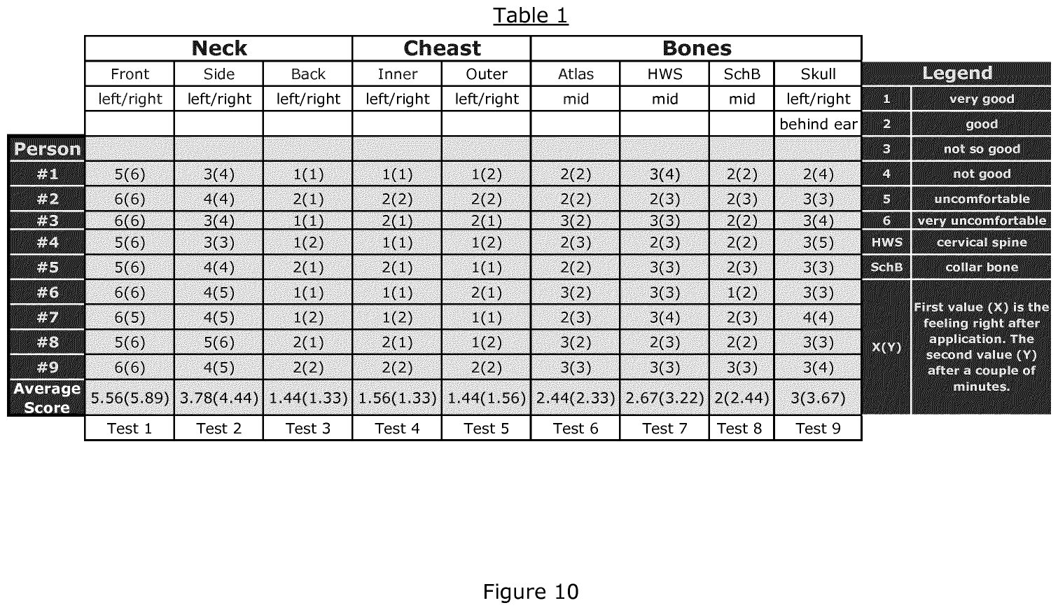

FIG. 9 depicts four different views of a contact plate 300 comprising a concave second surface 370. FIG. 9a depicts a cross sectional view of the contact plate 300 comprising a concave second surface 370. FIG. 9b depicts a top view of contact plate 300 comprising a concave second surface 370. FIG. 9c depict a side view of the contact plate 300 comprising a concave second surface 370. Further, FIG. 9d depicts an aspectual view of a preferred embodiment of the contact plate 300.The contact plate 300 comprising a concave second surface 370, as shown in FIG. 9, can be also referred as a concave contact plate 300.

The concave contact plate 300 can comprise a circular outer shape with a diameter in the range of 30 to 55 mm. That is, in a top view, such as the one depicted in FIG. 9b, the shape of the contact plate 300 is a circle. In another embodiment, the convex contact plate can comprise an elliptical outer shape with diameters in the range of 30 to 55 mm. That is, in a top view, such as the one depicted in FIG. 9b, the shape of the shape of the contact plates 300 is an ellipse.

The concave contact plate 300 can comprise a first surface 310. The first surface 310 can be configured to attach the concave contact plate 300 to the vibration pad 20, preferably by means of gluing.

Further, the concave contact plate 300, comprise a concave second surface 370 on the part of the concave contact plate 300 that contacts the human body. That is, in at least one side view, such as the one depicted in FIG. 9c, the height of the concave contact plate 300 transitions from a higher value in the outer part of the concave contact plate 300, to a lower value towards the center of the concave contact plate 300. However, there exist at least one cross-sectional view (or side view) wherein the height of the contact plate 30 is constant. The height of the concave contact plate 300, can be in the range of 2 to 6 mm.

In other words, the concave contact plate 300 can comprise a first surface 310 and a concave second surface 370. For sake of a reference system the first side 310 is said to be lower than (or beneath) the second surface 370. The plane passing through the three lowest points of the first surface 310 can be defined a base plane, wherein the height of each point on the base plane is zero. The height of the concave contact plate 300 can be defined as the length of the segment perpendicular to the base plane from a point in the concave second surface 370 to the perpendicular plane. The height of the concave contact plate 300 can be in the range of 2 to 6 mm. Further, the thickness of the concave contact plate 300 can be defined as the distance between two points lying on a line perpendicular to the base plane such that one of the points lies on the first surface 310 and the other point lies on the concave second surface 370.

In some embodiments of the concave contact plate 300, there exist at least one plane perpendicular to the base plane such that the intersections between all the planes parallel to said plane with the concave second surface are arcs. In such embodiments, the concave second surface can comprise a shape that is similar to the inner shape of a cylinder. In some other embodiments, said intersection can be a baseless triangle (i.e. a “V” shape). In some other embodiments, said intersection can be a trapezoid (also referred as trapezium), preferably an isosceles trapezoid, without the longer base and with the smaller base being closest to the base plane.

In addition, there exist at least one plane perpendicular to the base plane, such that the intersections between all the planes parallel to said plane with the concave second surface are straight segments, preferably parallel to the base plane.

The concave contact plate 300 can comprise at least one hole 320. In the exemplary embodiment of FIG. 9 the contact plate 300 comprises one hole 320, which is depicted by the inner circle 320, concentric to the outer circle. The at least one hole 320 can be positioned anywhere in the concave second surface 370. The at least one hole 320 can have any shape as long as its area or the sum of areas of each individual hole is at most at least 2%, preferably at least 5% and at most 10%, such as 8% of the area of the concave second surface 370. The hole 320 can be advantageous as it can ventilate the contact area between the person's body and the concave contact plate 300, thus avoiding sweating of the skin in the contact areas. Furthermore, the holes 320 can facilitate the maintenance between the concave contact plate 300 and the vibration pads 20. If the hole 320 would not be present, due to vibrations the trapped air between the concave contact plate 300 and the vibration pads 20 can experience a fluctuating pressure, which can achieve high peaks that can damage the connection between the concave contact plate 300 and the vibration pads 20. The presence of such hole 320 cannot allow the pressure of the air between the concave contact plate 300 and the vibration pads 20 reach very high peaks as the air can go in and out.

In a preferred embodiment, rear vibration pads 20 (i.e. the vibration pads 20 positioned in the main frame 100 contacting the back of the neck of the person) are joint with concave contact plates 300. Since the back of the neck has a convex, the use of the concave contact plates 300 on the rear vibration pas 20, is advantageous as they can lie more firmly on the neck. At the same time, with such embodiment the concave contact plates 300 can create a bigger contact area with the back of the neck.

In a preferred embodiment, the front vibration pads 20 (i.e. the vibration pads 20 positioned in the left section 101 and right section 102) are joint with convex contact plates 300. The convex contact plates 300 can be advantageous as the contact surface with the body can become angle independent. That is, the contact surface between the convex contact plates 300 and the chest of the person is not influenced much from the inclination of the front vibration pads 20 with respect to the chest of the person. Also, the convex shape of the convex contact plates 300 can be more adaptive to the shape of the chest of the person wearing the music collar 10.

In an embodiment, the vibration pads 20 can be controlled independently. That is, they are not supplied with the same electrical signal, but can be supplied with different electrical signals. In other words, each vibration pad 20 comprises its own channel. Put it more simply, each vibration pad 20 are connected by its own set of wires. Thus, in such embodiment, each vibration pad 20 can be controlled independently. For example, the vibration pads 20 are activated sequentially in a clockwise direction. Using different combinations, vibration can be created on different body sides or on different combinations of body sides that can create haptic feedback with a multi-directional character. Put it in simple words, the brain would percept the vibrations like they have a direction, or are following a certain direction. In the above example where the vibration pads 20 are activated sequentially in a clockwise direction, our brain would percept the vibrations like having a directional clockwise flow. Such effect can create a better experience for the user.

In another embodiment, the sequence of vibrations can be controlled by a software running on the device connected with the music collar 10. That is, through the software program the person wearing the music collar 10 can define certain sequences and combinations of activating the vibration pads 20. Such a feature can be used for massage purposes.

1-34. (canceled)

35. A music collar, wherein the music collar is configured as a wear around the neck device, and the music collar comprises:
a main frame, comprising at least a rear-left vibration pad and a rear-right vibration pad, configured to directly or indirectly contact soft tissue of a back part of the neck of a person wearing the music collar; and wherein
the vibration pads transform an input electrical signal to vibrations and are configured transfer the vibrations to the soft tissue of a person wearing the music collar;
a left vibration section connected with the main frame at the left of the main frame, and wherein the left vibration section comprises a front-left vibration pad, configured to directly or indirectly contact the soft tissue of the left part of the chest, preferably the soft tissue below the left clavicle bone comprising the left part of the pectoralis major muscle, more preferably the pars clavicularis part of the left pectoralis major muscle of a person wearing the music collar;
a right vibration section connected with the main frame at the right of the main frame and wherein the right vibration section comprises a front-right vibration pad, configured to directly or indirectly contact the soft tissue of the right part of the chest, preferably the soft tissue below the right clavicle bone comprising the right part of the pectoralis major muscle, more preferably the pars clavicularis part of the right pectoralis major muscle of a person wearing the music collar.

36. The music collar according to claim 35, wherein the rear-left vibration pad is configured to contact the soft tissue comprising the left part of the superior fibers of the trapezius muscle of the person wearing the music collar.

37. The music collar according to claim 35, wherein the rear-right vibration pad is configured to contact the soft tissue comprising the right part of the superior fibers of the trapezius muscle of the person wearing the music collar.

38. The music collar according to claim 35, wherein the main frame comprises a curved shape, such as a half-circle shape, configured to facilitate the wear around the neck of the music collar, preferably surrounding the neck of the person wearing the music collar at an angle of at least 120° and at most 240°.

39. The music collar according to claim 35, wherein the music collar is configured to avoid contact with the collar bone by bridging over the collar bone, of the person wearing the music collar.

40. The music collar according to claim 35, wherein the vibration sections comprise an elongated part and a mount part and wherein the mount part is configured to mount a vibration pad on it.

41. The music collar according to claim 40 wherein the mount part is thicker than the elongated part such that the mount part can lie on the chest of the person wearing the music collar allowing the elongated part to bridge over the collar bone without contacting it.

42. The music collar according to claim 35, further comprising an amplifier module configured to adjust at least one of the amplitude or the frequency of the electrical signal supplied to the vibration pads.

43. The music collar according to claim 42, wherein the amplifier module is configured to cut-off frequencies above a threshold value, such that the electrical signal supplied to the vibration pads comprises low frequency signals such as the deep tones, the bass or signals with frequency of no more than 250 Hz.

44. The music collar according to claim 42, wherein the amplifier module is configured to cut-off frequencies above 250 Hz, such that the electrical signal supplied to the vibration pads comprises low frequency signals such as the deep tones, the bass or signals with frequency of no more than 250 Hz.

45. The music collar according to claim 35, further comprising volume controls configured to control the intensity of the vibrations produced by the vibration pads.

46. The music collar according to claim 35, further comprising a wire connector configured to facilitate a wired connection between the music collar and an external device such as headphones, mobile phone or digital audio player.

47. The music collar according to claim 35, further comprising a wireless connector configured to facilitate a wireless connection, such as a Bluetooth® connection, between the music collar and an external device, such as headphones, mobile phone or digital audio player.

48. The music collar according to claim 47, wherein a volume control is configured to adjust the intensity of vibrations on the vibration pads without influencing the volume of the audio in the external device.

49. The music collar according to claim 35, wherein a multi-directional perspective of vibrations is created by independently controlling at least two vibrations pads.

50. A contact plate, preferably for use with a music collar, more preferably for use with a vibration pad, comprising:
a first surface, configured to attach the contact plate to a vibration pad; and
at least one of a convex second surface and/or a concave second surface configured to facilitate the contact between the vibration pad and the body of a person; and at least one hole; wherein the contact plate comprises
a circular or elliptical outer shape; and
wherein the contact plate further comprises an outer diameter in the range of 20 to 80 mm; and
wherein a thickness of the contact plate is in the range of 0.5 to 15 mm.

51. The contact plate according to claim 49, wherein the sum of the areas of at least one hole is at least 2%, and at most 10%, of the total area of the contact plate.

52. A system comprising:
a music collar, comprising at least two rear vibration pads contacting the back of the neck of a person wearing the music collar, according to claim 35; and
at least one contact plate attached to the vibration pads of the music collar, the contact plate comprising:
a first surface, configured to attach the contact plate to a vibration pad; and
at least one of a convex second surface and/or a concave second surface configured to facilitate the contact between the vibration pad and the body of a person; and at least one hole; wherein the contact plate comprises
a circular or elliptical outer shape; and
wherein the contact plate further comprises an outer diameter in the range of 20 to 80 mm; and
wherein a thickness of the contact plate is in the range of 0.5 to 15 mm;
wherein the contact plates are configured to facilitate the contact between the vibration pads and the body of a person wearing the music collar.

53. The system according to claim 52, wherein the contact plates attached to the rear vibration pads comprise a concave second surface.

54. The system according to claim 52, wherein the contact plates attached to the front vibration pads comprise a convex second surface.
